(19) United States
(12) Patent Application Publication
(10) Pub. No.: US 2004/0017365 A1
(43) Pub. Date: Jan. 29, 2004

(54) Image display device having a drive circuit employing improved active elements

(75) Inventors: Mutsuko Hatano, Kokubunji (JP); Shinya Yamaguchi, Mitaka (JP); Takeo Shiba, Kodaira (JP); Mitsuharu Tai, Kokubunji (JP); Hajime Akimoto, Ome (JP)

Correspondence Address: Stanley P. Fisher, Reed Smith LLP, Suite 1400, 3110 Fairview Park Drive, Falls Church, VA, 22042-4503, US

(73) Assignee: Hitachi, Ltd.

(21) Appl. No.: 10/601,643

(22) Filed: Jun. 24, 2003

(30) Foreign Application Priority Data
Jul. 24, 2002 (JP) P2002-215021

(51) Int. Cl. G09G 5/00

(52) U.S. Cl. 345/204

(57) ABSTRACT

An image display device has an active matrix substrate provided with a drive circuit formed of high-performance active elements such as thin film transistors which operate with high mobility for driving pixel sections arranged in a matrix configuration. The image display device has discontinuous converted regions (virtual tiles) TL formed of roughly-band-shaped-crystal silicon films in circuit sections constituting a drive circuit DDR disposed around a pixel region PAR on the active matrix substrate SUB1, and has the drive circuit DDR formed of active elements such as thin film transistors fabricated in the discontinuous converted regions TL with their channel direction in a direction of growth direction of the roughly-band-shaped-crystal silicon films.

### BACKGROUND OF THE INVENTION

The present invention relates to a display device, and particularly to an image display device employing active elements for its drive circuit formed by converted semiconductor films obtained by irradiating laser light onto the semiconductor films formed on an insulating substrate and thereby converting crystal structures of the semiconductor films.

Active matrix type display devices (also called active-matrix-type drive system image display devices, or simply called display devices) are widely used which employ active elements such as thin film transistors as drive elements for pixels arranged in a matrix configuration. Most of the image display devices of this kind can display images of good quality by disposing on their insulating substrate a large number of pixel circuits and drive circuits which are composed of active elements such as thin film transistors (TFTS) formed using by silicon films as their semiconductor films. Thin film transistors are typical examples of active elements, and therefore the following explanation will be made by using thin film transistors as the active elements, by way of example.

In a thin film transistor using a noncrystalline (amorphous) silicon semiconductor film which has generally been used as a semiconductor film, there is a limit to its carrier (electron or hole) mobility representing performance of a thin film transistor, and consequently, it has been difficult to form a circuit requiring high speed operation and high performance by using thin film transistors.

For realizing thin film transistors having high mobility required for proving an image of better quality, it is effective to fabricate thin film transistors by using polysilicon films (hereinafter also called polycrystalline silicon films) obtained by converting (recrystallizing) amorphous silicon films (hereinafter also called noncrystalline silicon films) into the polysilicon films beforehand. This conversion is performed by a technique of annealing amorphous silicon films by irradiating laser light such as excimer laser light onto the amorphous silicon films.

The laser annealing techniques of this kind are described in detail in (1) T. C. Angelis et al., “Effect of Excimer Laser Annealing on the Structural and Electrical Properties of Polycrystalline Silicon Thin-Film Transistor,” J. Appl. Phy., Vol. 86, pp. 4600-4606, 1999, (2) H. Kuriyama et al., “Lateral Grain Growth of Poly-Si Films with a Specific Orientation by an Eximer Laser Annealing Method,” Jpn. J. Appl. Phy., Vol. 32, pp. 6190-6195, 1993, and (3) K. Suzuki et al, “Correlation between Power Density Fluctuation and Grain Size Distribution of Laser annealed Poly-Crystalline Silicon,” SPIE Conference, Vol. 3618, pp. 310-319, 1999, for example.

The following will explain a method of converting an amorphous silicon film by crystallizing using an irradiation of excimer laser light by reference to FIGS. 34(A) and 34(B). FIGS. 34(A) and 34(B) illustrate a method of crystallizing an amorphous silicon film by scanning excimer laser light most generally used, FIG. 34(A) is a perspective view of a configuration of an insulating substrate provided with a semiconductor layer to be irradiated, and FIG. 34(B) illustrates a condition of the semiconductor layer being converted by the irradiation of the laser light. The insulating substrate is made of glass or ceramics.

In FIGS. 34(A) and 34(B), initially an amorphous silicon film ASI is deposited on an insulating substrate SUB with an undercoating film (SiN, for example, but not shown) therebetween, and then the amorphous silicon film ASI over the entire surface of the insulating substrate SUB is converted into a polysilicon film PSI by irradiating excimer laser light ELA in the form of a line of several to hundreds of nm in width on the amorphous silicon film ASI, and scanning the excimer laser light on the amorphous silicon film ASI by moving an area of the amorphous silicon film ASI to be irradiated in one direction (an x direction) as indicated by an arrow for each one or several pulses of the irradiation, thereby to anneal the amorphous silicon film ASI.

The thus converted polysilicon film PSI is subjected to various processing such as etching, an interconnection line forming, and ion implantation, so that circuits having active elements such as thin film transistors are formed in individual pixel sections or drive sections. An active matrix type image display device such as a liquid crystal display device or an organic EL display device is fabricated by using the above processed insulating substrate.

FIGS. 35(A) and 35(B) are a fragmentary plan view of the laser-light-irradiated portion of FIG. 34(B) and a plan view of an essential portion of a thin film transistor section for explaining an example of its configuration. As shown in FIG. 35(A), a large number of crystallized silicon grains (polycrystalline silicon) PSI of about 0.05 μm to 0.5 μm in size grow uniformly over an area irradiated by laser light. Most of grain boundaries of individual silicon grains (i.e. silicon crystals) are closed without break. That is to say, grain boundaries exist completely and continuously between adjacent silicon grains. In FIG. 35(A), a box indicates a transistor section TRA intended for a semiconductor film of an individual active element such as a thin film transistor. Conventional conversion of a silicon film means such crystallization.

In a case where a pixel circuit is formed by using the above-described converted silicon film (the polysilicon film PSI), to utilize a portion of crystallized silicon as a transistor section, an island of a silicon film is formed by etching away an unwanted area, leaving the area intended for the transistor section TRA shown in FIG. 35(A), and then a thin film transistor is fabricated by disposing a gate insulating film (not shown), a gate electrode GT, a source electrode SD1, and a drain electrode SD2.

### SUMMARY OF THE INVENTION

In the above conventional technique, active elements such as thin film transistors providing good operating performance are fabricated by using a polysilicon film converted on an insulating substrate, but, as explained above, there is a limit to carrier mobility (electron or hole mobility, hereinafter also referred to merely as electron mobility) in a channel of a thin film transistor, for example, using crystals of a polysilicon film. That is to say, a grain boundary of each of crystal grains of the polysilicon film crystallized by irradiation of excimer laser light is closed as shown in FIG. 35(A), and consequently, there is a limit to realization of increasing of carrier mobility in a channel between a source electrode and a drain electrode. Drive circuit density has increased with recent increasing of resolution capability. Higher carrier mobility is required of active elements such as thin film transistors of extremely high circuit density in such drive circuits.

It is an object of the present invention to provide an image display device with provided with an active matrix substrate having a high-performance thin film transistor circuit or the like operating with high mobility for drive elements for driving pixel sections arranged in a matrix configuration. The present invention is not limited to conversion of semiconductor films formed on an insulating substrate of an image display device, but is equally applicable to the conversion of semiconductor films formed on other substrates, for example, a silicon wafer.

As means for solving the above problems, initially irradiating excimer laser light over an entire area of an amorphous silicon film formed over an entire surface of an insulating surface and thereby converting the amorphous silicon film into a polysilicon film, or initially fabricating an insulating substrate having formed on it a polysilicon film, then irradiating pulse-modulated laser light by using solid-state laser or pseudo CW laser light selectively onto a polysilicon film of a drive circuit region disposed around a pixel region on the insulating substrate, and at the time scanning the laser light in a specified direction, the present invention forms discontinuous converted regions of roughly-band-shaped-crystal silicon films having crystal sizes greatly converted such that crystals having grown in the scanning direction have continuous grain boundaries.

The discontinuous converted regions are selected to be roughly rectangular. When desired circuit sections such as drive circuit sections are fabricated in these discontinuous rectangular converted regions, directions of channels of active elements such as thin film transistors of individual circuits constituting the desired circuit sections are selected to be approximately parallel with directions of the grain boundaries of the roughly-band-shaped-crystal silicon films. In this specification, a technique of fabricating discontinuous converted regions of roughly-band-shaped-crystal silicon films by irradiation of the pulse-modulated laser light or the pseudo CW laser light is referred to as SELAX (Selectively Enlarging Laser Crystallization).

In fabrication of an image display device in accordance with the present invention, the discontinuous converted regions of the roughly-band-shaped-crystal silicon films are preferably fabricated by using the SELAX process by selective and reciprocating irradiation of laser light onto polysilicon films in the drive circuit regions. It is possible to form this discontinuous converted regions over the entire drive circuit region, but it is recommended that these discontinuous converted region are formed in the roughly rectangular shape in regions required in consideration of circuit density of the drive circuits and others. Especially, by disposing the roughly rectangular discontinuous converted regions mainly in the above-described required regions within the drive circuit region, the efficiency of laser light irradiation process and the film quality of individual roughly-band-shaped-crystal silicon films are homogenized in all the discontinuous converted regions.

The roughly-band-shaped-crystal silicon film in accordance with the present invention is a collection of single-crystals of 0.1 μm to 10 μm in width and 1 μm to 100 μm in length, for example, where the width and the length are measured in directions perpendicular to and parallel with a scanning direction of laser light, respectively. Using of such roughly-band-shaped-crystal silicon films ensures good carrier mobility. In the case of electron mobility, it is approximately 300 cm²/V·s or more, and is preferably 500 cm²/V·s or more.

On the other hand, in the conventional conversion technique of silicon films using excimer laser light, many crystallized silicon grains (polysilicon) of about 0.05 μm to about 0.5 μm grow randomly in regions irradiated with the laser light. Electron mobility of such polysilicon films is approximately 200 cm²/V·s or less, and is approximately 120 cm²/V·s on the average. Such polysilicon films are improved in performance compared with amorphous silicon films having electron mobility of 1 cm²/V·s or less. The discontinuous converted regions formed of the roughly-band-shaped-crystal silicon films in accordance with the present invention exhibit electron mobilities higher than the above-mentioned electron mobilities.

The silicon films formed in pixel regions on an insulating substrate of an image display device in accordance with the present invention are polysilicon films into which amorphous silicon films fabricated by a CVD or sputtering method are converted by irradiation of excimer laser light, and the silicon films disposed in its drive circuit regions are roughly-band-shaped-crystal silicon films having their crystal structures further converted by irradiating pulse-modulated laser light using a solid-state laser or a pseudo CW laser onto the polysilicon films. Here, the pulse modulation means that obtained by using a modulating method which changes pulse widths, or intervals between pulses, or both of them. Specifically, such pulses are obtained by subjecting CW (Continuous-Wave) laser to electrooptic modulation.

In the present invention, by irradiating and scanning pulse-modulated laser light or pseudo CW laser light selectively on polysilicon films in drive circuit regions on an insulating substrate, selectively irradiated regions, that is, regions converted into roughly-band-shaped-crystal silicon films are formed in an array of roughly rectangular shapes on a surface of an insulating substrate. Hereinafter, these roughly rectangular regions are also called virtual tiles. The converted regions of the above-mentioned virtual tiles and individual circuit sections of the virtual tiles are divided into an array of plural blocks each composed of plural converted regions, correspondingly to circuit sections or circuits for which the converted regions are intended. In addition to the above-described advantages, the adoption of such virtual tiles eliminates the need for irradiating the laser light onto semiconductor film regions to be etched away during a subsequent process fabricating thin film transistor and others, and reduces unwanted operations greatly.

In the present invention, it is preferable for converting amorphous silicon films into polysilicon films to use excimer laser, continuous-wave solid-state laser having an oscillation wavelength in a range of from 200 nm to 1200 nm, or pulsed solid-state laser having an oscillation wavelength in the same range as above. It is preferable that the continuous-wave laser light has an oscillation wavelength absorbable by amorphous silicon to be annealed, that is, in a range of from ultraviolet to visible wavelengths, and more specifically, Ar laser, Nd:YAG laser, Nd:YVO₄ laser, and second and third harmonics, or fourth harmonics of Nd:YLF laser can be used. However, the second harmonic (532 nm in wavelength) of LD (Laser Diode)-excited Nd:YAG laser, or the second harmonic (532 nm in wavelength) of Nd:YVO₄ laser is most preferable when its output power and stability are considered. The upper and lower limits of such wavelengths are determined by a trade-off between a light-wavelength range efficiently absorbed by a silicon film and an economically available stable laser light source. Besides, the above-mentioned polysilicon film can be formed in a process of forming a film. The polysilicon film can be formed on a substrate or an undercoating film directly by a cat-CVD (catalytic vapor deposition), for example.

The solid-state laser employed in the present invention has features that laser light absorbable by a silicon film can be supplied stably, and that the solid-state laser is not subject to heavy economical burdens such as gas replacement and degradation in an oscillator section, which are specific to gas laser, and consequently, the solid-state laser is a preferable means for economically converting the silicon film. However, the present invention does not positively exclude the use of excimer laser of 150 nm to 400 nm in wavelength.

In the present invention, it is preferable for converting polysilicon films into the roughly-band-shaped-crystal silicon films to use continuous-wave solid-state laser having an oscillation wavelength in a range of from 200 nm to 1200 nm, or pulsed solid-state laser, pulse-modulated laser, or pseudo CW (continuous-wave) solid-state laser. By using the so-called mode locking technique with high-frequency pulsed laser used as pseudo continuous-wave laser, pulsed laser of 100 MHz or more can be obtained from a wavelength in the UV region. Even in a case where short-pulse laser is employed for irradiation, if one irradiation pulse onto a silicon film is followed by a succeeding irradiation pulse within a solidifying time of silicon (<100 ns), the silicon film can extend its dissolving time without solidifying, and therefore the high-frequency laser can be considered as the pseudo continuous-wave laser. Further, by combining the high-frequency laser with an electro-optic modulation, and thereby causing the laser energy to be absorbed by the silicon film with a high efficiency, a crystallized silicon film (hereinafter also called a roughly-band-shaped-crystal silicon film) can be obtained which has its longitudinal direction aligned with a scanning direction of the laser light.

In the present invention, it is desirable that a spatial distribution of intensity of laser light is homogenized by adjusting the laser light optically, and then the laser light is collected by using a lens system and is irradiated onto the silicon film.

In the present invention, the irradiation width of the laser light scanned with intermittent irradiation is determined by considering economics in view of a width of regions required for drive circuit regions and a ratio of the irradiation width to a pitch of the arrangement of the regions. The width and length of the irradiated area corresponding to the shape of the above-described virtual tiles are determined by considering the size of intended circuits and the scale of integration.

The present invention is not limited to the type in which laser light is scanned on the insulating substrate by moving the laser light, and but the present invention is configured such that irradiation by laser light is turned on and off in synchronism with movement of the XY stage mounting the insulating substrate.

In the present invention, it is desirable that the irradiation of continuous pulsed laser light is scanned at a speed in a range of from 50 mm/s to 3000 mm/s. The lower limit of the scanning speed is determined by considering a trade-off between a time required for scanning the drive circuit regions within the insulating substrate and the economic burden. Here, an upper limit of the irradiation speed is set by performance of a scanning machine.

In the present invention, the irradiation of laser light is scanned by using a light beam into which the laser light is focused by an optical system. Here, an optical system may be used which focuses a single laser light into a single beam. However, a method of splitting a single laser light into plural laser lights, and irradiating the plural laser lights onto plural rows of pixel sections simultaneously is suitable for processing a large-sized substrate in a short period of time, and can improve laser light irradiation efficiency greatly.

In the present invention, plural laser oscillators can be operated in parallel for the laser light irradiation, and this method is preferable especially for processing a large-sized substrate in a short period of time.

In the present invention, active element circuits formed of silicon films converted into the roughly-band-shaped-crystal silicon films are not limited to general top-gate type thin film transistor circuits, but can be applicable to bottom-gate type thin film transistor circuits. In a case where a single-channel circuit composed of n-channel MIS only or p-channel-MIS only, the bottom-gate type thin film transistor circuits are sometimes preferable in view of simplification of manufacturing processes. In such a case, silicon films on gate lines with insulating films therebetween are converted into the roughly-band-shaped-crystal silicon films by laser light irradiation, and therefore it is preferable to use a refractory metal as a material for gate lines, and use of a material made chiefly of tungsten (w) or molybdenum (Mo) is preferable for the gate lines.

Utilization of the insulating substrate having semiconductor structures such as thin film transistors of drive circuits in accordance with the present invention, as an active matrix substrate, is capable of providing a liquid crystal display device superior in image quality at a reduced cost. Further, utilization of the active matrix substrate of the present invention is also capable of providing an organic EL (Electroluminescent) display device superior in image quality at a reduced cost. Further, the present invention is not to liquid crystal display devices or organic EL display devices, but is applicable to active matrix type image display devices of other types having similar semiconductor structures in their drive circuits, and further, is also applicable to various kinds of semiconductor devices fabricated in semiconductor wafers.

### BRIEF DESCRIPTION OF THE DRAWINGS

FIG. 1 is a plan view schematically illustrating an embodiment of a liquid crystal display device to which an image display device in accordance with the present invention is applied;

FIG. 2 is a block diagram illustrating an embodiment of a circuit configuration of a data drive circuit section in FIG. 1;

FIG. 3 is an illustration of a configuration of a sampling switch section constituting a sampling circuit in FIG. 2;

FIG. 4 is an enlarged plan view illustrating a configuration of one of the sampling switch circuits formed in the virtual tiles shown in FIG. 3;

FIG. 5 is a schematic plan view of a channel portion of a thin film transistor (TFT) obtained by further enlarging an essential portion of FIG. 4 so as to indicate a crystal orientation of a roughly-band-shaped-crystal silicon film;

FIG. 6 is an enlarged plan view of a portion designated “B” of one virtual tile shown in FIG. 4;

FIG. 7 is a cross-sectional view of FIG. 6 taken along line C-C′;

FIG. 8 is a timing chart for explaining operation of the configuration shown in FIG. 6;

FIG. 9 is a block diagram similar to that of FIG. 2, and schematically illustrates another embodiment of a circuit configuration of a data drive circuit section in which the image display device of the present invention is applied to a liquid crystal display device;

FIGS. 10(A) to 10(C) are illustrations of process steps for explaining an embodiment of a method of fabricating an image display device in accordance with the present invention;

FIGS. 11(A) to 11(C) are illustrations of process steps following the process step of FIG. 10(C), for explaining the embodiment of the method of fabricating an image display device in accordance with the present invention;

FIGS. 12(A) to 12(C) are illustrations of process steps following the process step of FIG. 11(C), for explaining the embodiment of the method of fabricating an image display device in accordance with the present invention;

FIGS. 13(A) to 13(B) are illustrations of process steps following the process step of FIG. 12(C), for explaining the embodiment of the method of fabricating an image display device in accordance with the present invention;

FIGS. 14(A) to 14(B) are illustrations of process steps following the process step of FIG. 13(B), for explaining the embodiment of the method of fabricating an image display device in accordance with the present invention;

FIG. 15 is an illustration of a process step following the process step of FIG. 14(B), for explaining the embodiment of the method of fabricating an image display device in accordance with the present invention;

FIGS. 16(A) to 16(C) are illustrations for explaining a process of forming discontinuous converted regions (virtual tiles) of roughly-band-shaped-crystal silicon films;

FIGS. 17(A) and 17(B) are illustrations of a manner of scanning a laser light, and a crystal structure of the roughly-band-shaped-crystal silicon film, respectively;

FIGS. 18(A) and 18(B) are illustrations for explaining differences in electron mobility in channels of thin film transistors due to differences in crystal structure between silicon films;

FIG. 19 is an illustration of a configuration of an example of a laser light irradiation equipment;

FIG. 20 is a plan view illustrating an embodiment of a layout of the virtual tiles;

FIG. 21 is an illustration of an example of a laser irradiation process using the laser light irradiation equipment of FIG. 19;

FIG. 22 is an illustration of operation of laser light scanning for forming virtual tiles of roughly-band-shaped-crystal silicon films SPSI on a large-sized multiple-device-material insulating substrate;

FIGS. 23(A) and 23(B) are a plan view of one active matrix substrate illustrating an example of a position of one of the virtual tiles formed by the operation of FIG. 22, and an enlarged plan view of a portion indicated by an arrow “A” in FIG. 23(A), respectively;

FIGS. 24(A) and 24(B) are enlarged plan views similar to FIG. 23(B), and illustrating other arrangements of blocks of virtual tiles, respectively;

FIG. 25 is a plan view of one active matrix substrate for illustrating another example of positions of virtual tiles;

FIG. 26 is a plan view of one active matrix substrate for illustrating still another example of positions of virtual tiles;

FIGS. 27(A) to 27(C) are illustrations of a first example of a process of forming positioning marks on an active matrix substrate, and of irradiating continuous-wave pulsed laser light by using the positioning marks as positioning targets;

FIGS. 28(A) to 28(C) are illustrations of a second example of a process of forming positioning marks on an active matrix substrate SUB1, and of irradiating continuous-wave pulsed laser light by using the positioning marks as positioning targets;

FIGS. 29(A) to 29(C) are illustrations of a third example of a process of forming positioning marks on an active matrix substrate SUB1, and of irradiating continuous-wave pulsed laser light by using the positioning marks as positioning targets;

FIG. 30 is an exploded perspective view illustrating a configuration of a liquid crystal display device in accordance with a first embodiment of an image display device of the present invention;

FIG. 31 is a cross-sectional view of the liquid crystal display device of FIG. 30 taken along line Z-Z;

FIG. 32 is an exploded perspective view illustrating a configuration example of an organic EL display device in accordance with a second embodiment of an image display device of the present invention;

FIG. 33 is a plan view of the organic EL display device obtained by assembling the constituent components shown in FIG. 32 as an integral unit;

FIGS. 34(A) and 34(B) are illustrations for explaining a method of crystallizing an amorphous silicon film by irradiating and scanning general excimer pulsed-laser; and

FIGS. 35(A) and 35(B) are a partial plan view of the portion irradiated by laser light of FIG. 34(B), and a plan view of an essential portion of a thin film transistor section for illustrating an example of its configuration.

### DETAILED DESCRIPTION OF THE PREFERRED EMBODIMENTS

The embodiments in accordance with the present invention will be explained by reference to the drawings.

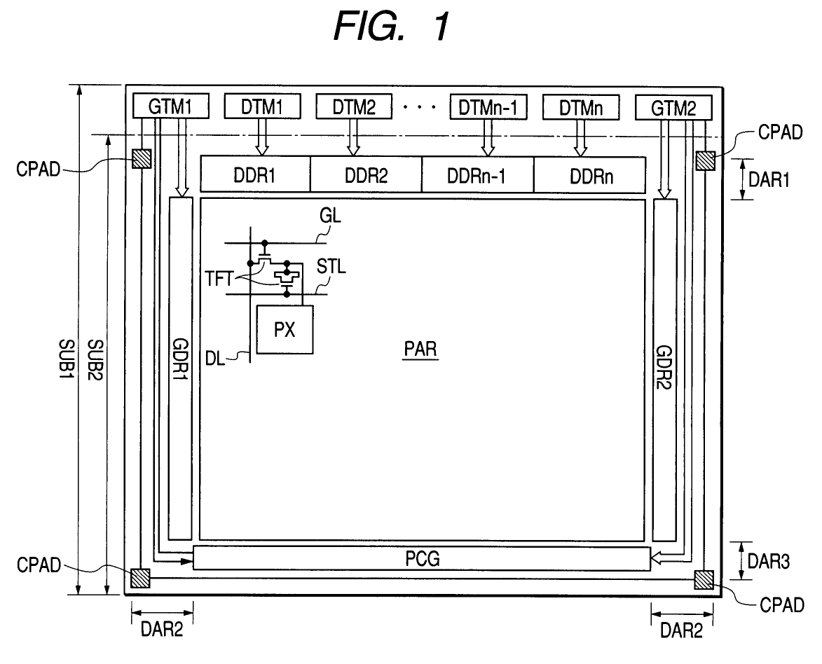

FIG. 1 is a plan view schematically illustrating an embodiment of a liquid crystal display device to which an image display device in accordance with the present invention is applied. In FIG. 1, reference character SUB1 denotes an active matrix substrate, SUB2 is a color filter substrate attached to the active matrix substrate SUB1, and a side of the color filter substrate SUB2 set back from a corresponding side of the active matrix substrate SUB1 attached to the color filter substrate SUB2 with a liquid crystal layer therebetween is indicated by an imaginary line. Here, a color filter or a common electrode is formed on an inner surface of the color filter substrate SUB2, but they are not shown in FIG. 1. The following explanation will be made using a liquid crystal display device employing a color filter substrate as an example, and this embodiment is equally applicable to liquid crystal display devices of the type disposing a color filter on the active matrix substrate.

The active matrix substrate SUB1 has a pixel region PAR at its central major portion, and drive circuit regions DAR1, DAR2, DAR3 outside of the pixel region PAR. Formed in the drive circuit regions DAR1, DAR2, DAR3 are circuits for supplying drive signals to a large number of pixels formed in the pixel region PAR. In this embodiment, in a first one of the long sides (the top side in FIG. 1) of the active matrix substrate SUB1 are disposed the drive circuit region DAR1 in which data drive circuits DDR1, DDR2, . . . , DDRn-1, and DDRn are formed for supplying display data to the pixels. In two sides adjacent to the drive circuit region DAR1 (the left and right sides in FIG. 1) are disposed drive circuit regions DAR2 having scanning circuits GDR1 and GDR2, respectively. In the other one of the long sides of the active matrix substrate SUB1 (the bottom side in FIG. 1) is disposed the drive circuit region DAR3 having a so-called precharge circuit. At four corners of an overlap between the active matrix substrate SUB1 and the color filter substrate SUB2 are provided pads CPAD for supplying a common electrode voltage to a common electrode on the color filter substrate SUB2 from the active matrix substrate SUB1. It is not always necessary to provide the pads CPAD at the four corners, but one pad CPAD may be provided at one of the four corners, or the pads CPAD may be provided at two or three of the four corners.

Formed on an edge portion in the above-mentioned first long side of the active matrix substrate SUB1 which extends beyond an edge in a corresponding one of the long sides of the color filter substrate SUB2 are input terminals DTM (DTM1, DTM2, . . . , DTMn-1 and DTMn) for the data drive circuits (DDR1, DDR2, . . . , DDRn-1 and DDRn) and input terminals GTM (GTM1, GTM2) for the scanning circuits GDR (GDR1, GDR2). Each of the pixels arranged in the pixel region PAR in a matrix configuration is disposed at an intersection of a corresponding one of data lines DL extending from the data drive circuit DDR and a corresponding one of gate lines GL extending from the scanning circuits GDR, and each of the pixels is composed of thin film transistors TFT and a pixel electrode PX.

With this configuration, turned on is a thin film transistor TFT which is connected to a gate line GL selected by the scanning circuit GDR (GDR1, GDR2), applied to a pixel electrode PX is a display data voltage supplied via a data line DL extending from the data drive circuits DDR (DDR1, DDR2, . . . , DDRn-1 and DDRn), and thereby an electric field is generated between the pixel electrode PX and a common electrode disposed on the color filter substrate SUB2. This electric field modulates orientation of liquid crystal molecules in a liquid crystal layer associated with the pixel electrode PX such that a pixel is displayed. In the liquid crystal display device shown in FIG. 1, the scanning circuit GDR is divided into two scanning circuits GDR1 and GDR2, which are disposed at the left-hand and right-hand sides of the active matrix substrate SUB1, respectively, and gate lines GL extending from the scanning circuits GDR1 and GDR2, respectively, are interleaved. However, the present embodiment is not limited to this arrangement, a single scanning circuit GDR is employed, and can be disposed at one of the left-hand and right-hand sides of the active matrix substrate SUB1. The subsequent explanation will be made by using the employment of the single scanning circuit GDR as an example. The present invention is applicable to all of the above-described drive circuit regions DAR1, DAR2 and DAR3, and is mainly applied to the drive circuit region DAR1 having a circuit configuration requiring the finest definition.

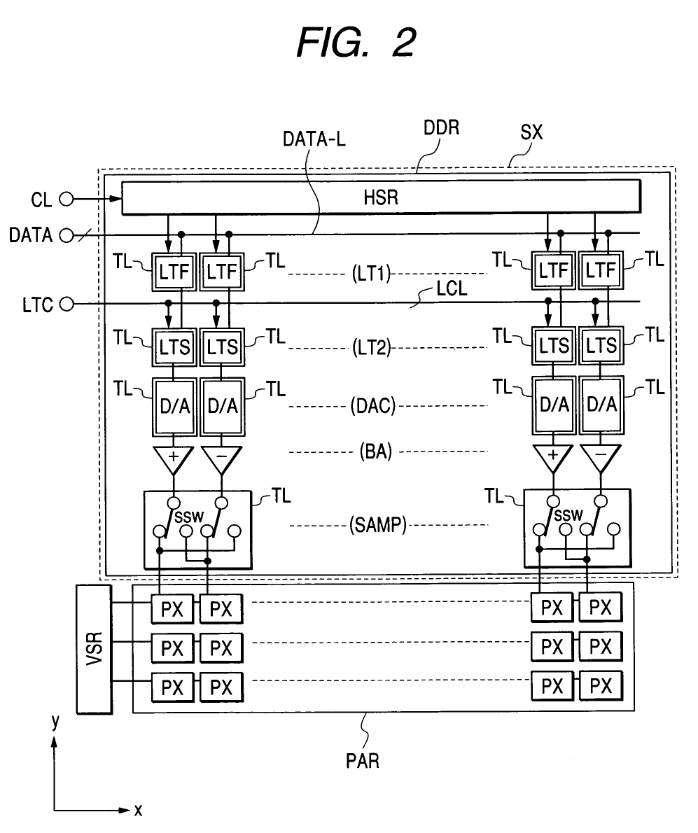

FIG. 2 is a block diagram illustrating an example of a circuit configuration of a data drive circuit section in FIG. 1. In FIG. 2, reference character PAR denotes a pixel region. In the pixel region, the above-explained pixels PX are arranged in a matrix of horizontal (x) and vertical (y) directions (the pixels are represented by the pixel electrodes PX). Reference character DDR denotes a data drive circuit. The data drive circuit DDR is comprised of a horizontal shift register HSR; a first latch circuit LT1 composed of latch circuits LTF; a second latch circuit LT2 composed of latch circuits LTS; a digital-analog converter DAC composed of digital-analog converter circuits D/A; a buffer circuit BA; a sampling circuit SAMP composed of sampling switches SSW; and a vertical shift register VSR.

Various kinds of clock signals CL supplied from a signal source (not shown) via input terminals DTM (see FIG. 1) enter the horizontal shift register HSR, and are transferred successively across the data drive circuit DDR (DDR1, DDR2, . . . , DDRn-1 and DDRn). Display data DATA are supplied to and are latched in the first latch circuit LT1 from data line DATA-L. The display data latched in the first latch circuit LT1 are transferred to and are latched in the second latch circuit LT2 by a latch control signal applied on a latch control line. The display data latched in the second latch circuit LT2 pass through the digital-analog converter DAC, the buffer circuit BA, the sampling circuit SAMP, and are supplied to the pixels PX connected to a gate line selected by the vertical shift register VSR disposed in the pixel region PAR.

In this embodiment, applied to the data drive circuit DDR are discontinuous converted regions formed of roughly-band-shaped-crystal silicon films which are converted by selective irradiation by scanning pulse-modulated laser light such that their grain boundaries are continuous in a direction of the scanning of the laser light. An area to be provided with these discontinuous converted regions is represented by reference character SX. It is ideal to carry out the discontinuous conversion for all the circuits in the region SX. However, the discontinuous conversion may be applied to some of the circuits in the region SX in view of productivity such as throughput. Areas to which the discontinuous conversion are applied are indicated by reference character TL. Here, by way of example, a case will be explained which converts silicon films of circuit portions forming the sampling switches in the discontinuously converted region SX in the form of rectangles. Hereinafter, such rectangular discontinuous converted regions will also be called virtual tiles for convenience' sake. The size of a virtual tile is selected to be that corresponding to a scale of a circuit to be fabricated in the virtual tile, or is selected to be the size capable of containing plural circuits.

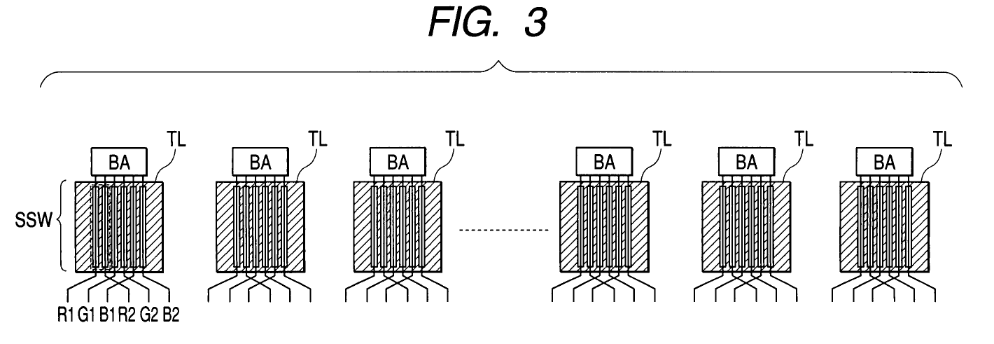

FIG. 3 is an illustration of a configuration of a sampling switch section constituting the sampling circuit SAM in FIG. 2. The sampling switches SSW are composed of analog switches, and their circuit configurations are formed of features finer and denser than those in other portions of the data drive circuit DDR. Each of the sampling switches SSW is formed in one of the virtual tiles TL arranged in a row in the x direction of FIG. 2. Thin film transistors constituting the sampling switches SSW are formed in the virtual tiles TL having high electron mobility, and consequently, can be fabricated with higher definition than other circuits since signal lines R1, G1, B1, R2, G2 and B2 are arranged in the pixel region with a pitch equal to a pixel pitch, an interconnection pattern is such that the output lines (signal lines) are arranged at close intervals at the output terminals of the sampling switches SSW, and are arranged at wide intervals on their pixel-region sides.

Each of the buffer circuits BA outputs 12 signals associated with two pixels, and here the six signals associated with each of the two pixels are three display signals of the same polarity as supplied from the data line DATA-L and three display signals obtained by inverting the above three display signals. In the following, a case will be explained in which each stage of the horizontal shift register HSR handles two pixels. Each color data (a video signal) for each pixel and its inverted color data form a pair. The sampling switch SSW determines the polarity of signals to be supplied to each of the pixels. As shown in FIG. 2, the sampling switch SSW is configured such that the polarity of signals supplied to a given pixel is opposite from that of signals supplied to pixels adjacent to the given pixel. In FIG. 3, reference character R1 denotes a signal line for a red sub-pixel of pixel 1 (not shown), G1 is a signal line for a green sub-pixel of pixel 1, B1 is a signal line for a blue sub-pixel of pixel 1, R2 is a signal line for a red sub-pixel of pixel 2, G2 is a signal line for a green sub-pixel of pixel 2, and B2 is a signal line for a blue sub-pixel of pixel 2.

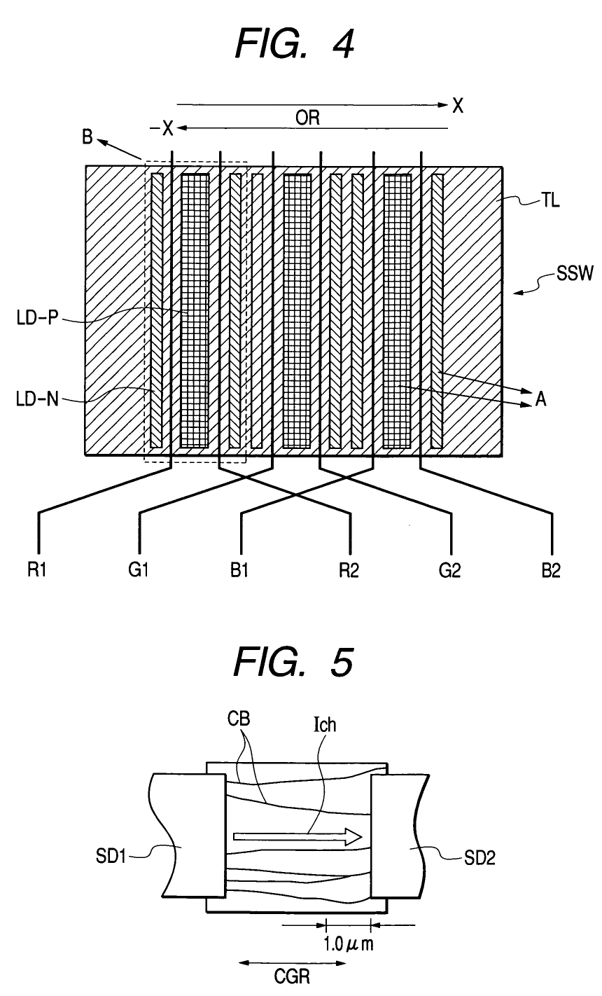

FIG. 4 is an enlarged plan view illustrating a configuration of one of the sampling switch circuits formed in the virtual tiles shown in FIG. 3, and FIG. 5 is a schematic plan view of a channel portion of a thin film transistor (TFT) obtained by further enlarging an essential portion of FIG. 4 so as to indicate a crystal orientation of a roughly-band-shaped-crystal silicon film. In FIG. 4, each of the virtual tiles TL is illustrated as formed for a respective one of the sampling switch circuits. Each of the virtual tiles TL is converted by scanning pulse-modulated laser light or pseudo CW laser light thereon in the x or (−x) direction. In the virtual tile TL, a portion denoted by reference character LD-P is a silicon island where p-type thin film transistors are to be fabricated, and a portion denoted by reference character LD-N is a silicon island where n-type thin film transistors are to be fabricated.

As shown in FIG. 5, grain boundaries present between single-crystals of roughly-band-shaped-crystal silicon films in the silicon islands LD-P and LD-N are approximately coincident with a crystal orientation CGR. A source electrode SD1 and a drain electrode SD2 are formed to face each other in the crystal orientation CGR. A flowing direction of a current (a channel current) Ich flowing between the source electrode SD1 and the drain electrode SD2 is selected to be approximately parallel with the crystal orientation CGR. Electron mobility in the channel is increased by selecting the crystal orientation CGR and the direction of the current Ich to be coincident with each other.

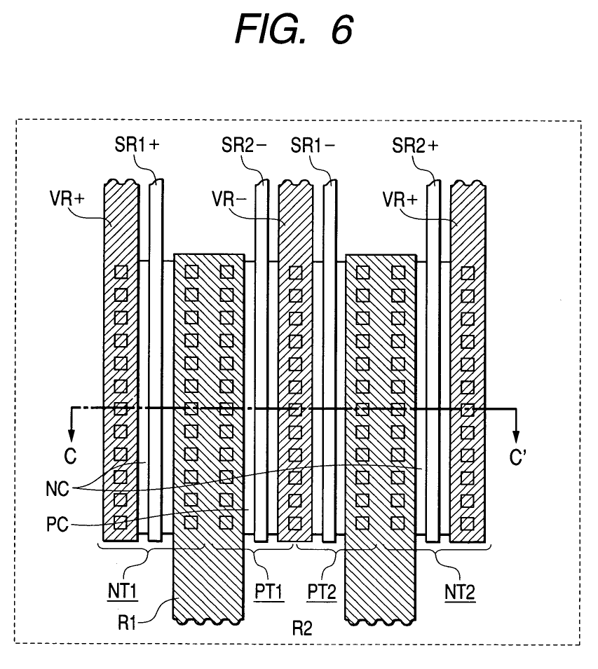

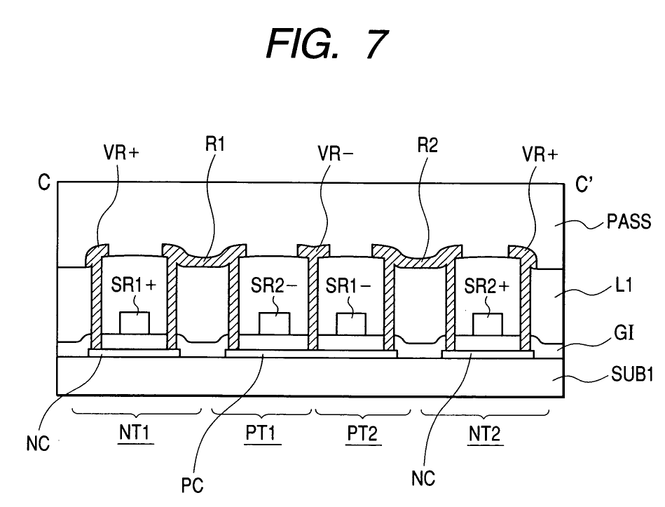

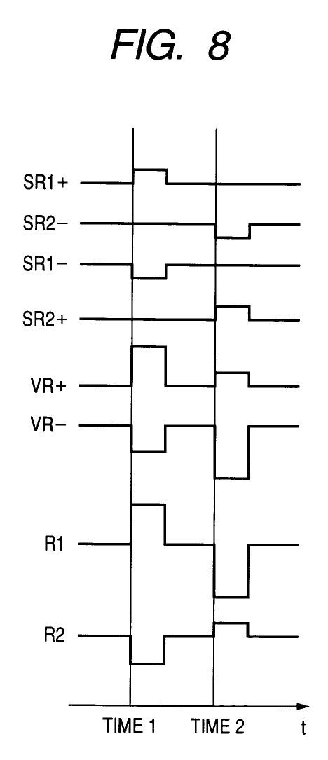

FIG. 6 is an enlarged plan view of a portion designated “B” of the virtual tile TL shown in FIG. 4, FIG. 7 is a cross-sectional view taken along line C-C′ of FIG. 6, and FIG. 8 is a timing chart for explaining operation of the configuration shown in FIG. 6. The configuration shown in FIGS. 6 and 7 and their operations will be explained by reference to FIGS. 7 and 2. In FIG. 6, reference characters NT1 and NT2 denote n-type thin film transistors, PT1 and PT2 are p-type thin film transistors, SR1+, SR1−, SR2+, and SR2− are signal lines for signals supplied from the horizontal shift register HSR via the buffer circuit BA, and VR+ and VR− are red data signals (red video signals). In FIG. 7, reference character SUB1 denotes the active matrix substrate, NC are n-type channels, PC is a p-type channel, GI is a gate insulating film, L1 is an interlayer insulating film, and PASS is an insulating protective film.

In FIG. 8, at time 1, the signal line SR1 is supplied with “1,” the signal line SR1− is supplied with “−1,” and at time 2, the signal line SR2− is supplied with “−1,” and the signal line SR2+is supplied with “1.” Here, the red data signal VR+ provides a signal of positive polarity for the red sub-pixel of the pixel 1 at time t1, and then provides a signal of positive polarity for the red sub-pixel of the pixel 2 at time 2. In a similar way, the red data signal VR− provides a signal of negative polarity for the red sub-pixel of the pixel 2 at time t1, and then provides a signal of negative polarity for the red sub-pixel of the pixel 1 at time 2. The n-type thin film transistor NT1 is turned on at time 1, and thereby outputs the red data signal VR+to the signal line R1. The p-type thin film transistor PT1 is turned on at time 2, and thereby outputs the red data signal VR− to the signal line R1. The n-type thin film transistor NT2 is turned on at time 2, and thereby outputs the red data signal VR+ to the signal line R2. The p-type thin film transistor PT2 is turned on at time 1, and thereby outputs the red data signal VR− to the signal line R2. With this configuration, the signal line R1 outputs positive-polarity data (a pixel signal) at time 1, and outputs negative-polarity data (a pixel signal) at time 2, and the signal line R2 outputs negative-polarity data (a pixel signal) at time 1, and outputs positive-polarity data (a pixel signal) at time 2.

In the above-explained embodiment, the virtual tiles TL of the roughly-band-shaped-crystal silicon film are provided to the respective circuit-forming portions of the sampling switches SSW constituting the sampling circuit SAMP, separately from each other. As described above, the sampling switch SSW are composed of analog switches, and their circuit configuration is especially complex and requires fine definition. By fabricating the roughly-band-shaped-crystal silicon films indicated as the virtual tiles TL in the above-explained circuit portions of the sampling switches SSW and forming the thin film transistors therein, the circuits having high electron mobility and finer definition can be realized, and consequently, fast image displays can be realized. Application of the virtual tiles TL is not limited to the above sampling circuit SAMP, but is also applicable to other desired portions in the region SX shown in FIG. 2.

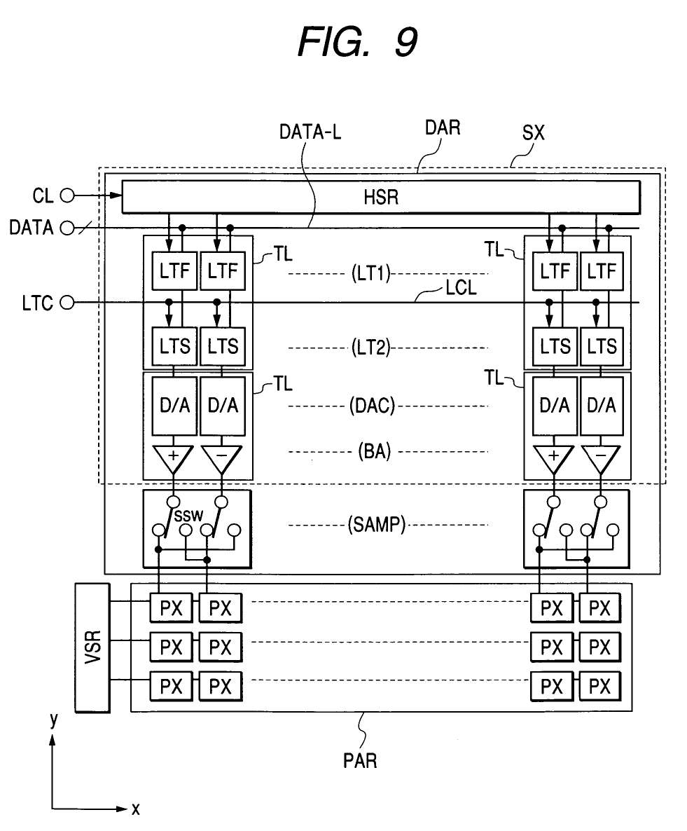

FIG. 9 is a block diagram similar to that of FIG. 2, and schematically illustrates another embodiment in which the image display device of the present invention is applied to a liquid crystal display device. In this embodiment, the virtual tiles TL are formed in two regions. One of the two regions includes the first latch circuit LT1 and the second latch circuit LT2, and the other of the two regions includes the digital-analog converter DAC and the buffer circuit BA. In this way, in this embodiment, the virtual tiles TL are arranged in two or more rows in parallel with the x direction, the remainder of the structure is similar to those in FIG. 2, and therefore the explanation overlapping that in connection with FIG. 2 is omitted. Here, to facilitate the explanation, an area of each of the virtual tiles TL is roughly indicated, and the virtual tile TL includes a block composed of plural virtual tiles each having an area corresponding to a scale of a circuit for which it is intended.

By fabricating the roughly-band-shaped-crystal silicon films indicated as the virtual tiles TL in the above-explained circuit portions and forming the thin film transistors therein, the circuits having high electron mobility and finer definition can be realized, and consequently, fast and high-definition image displays can be realized. Application of the virtual tiles TL is not limited to the above-mentioned regions, but the is also applicable to the sampling circuit SAMP as in the case explained in connection with FIG. 2. The size of each of the virtual tiles TL may be selected such that one of the first latch circuit LT1, the second latch circuit LT2, the digital-analog converter DAC, and the buffer circuit BA is contained therein either individually or in combination with one or more of the others. The size and arrangement of the virtual tiles TL explained in each of the above-explained embodiments may be determined by considering patterns of thin film transistors to be fabricated therein for their intended circuits. For example, virtual tiles TL in one row may be offset in their longitudinal direction from virtual tiles TL in a row adjacent to the one row, and it is not always necessary to adhere to the regular array of the virtual tiles TL.

In the above embodiments, the discontinuous converted regions (the virtual tiles) of the roughly-band-shaped-crystal silicon films are applied to the drive circuit region DAR1 forming the data-associated drive circuit, but the present invention is not limited to this configuration, and is also equally applicable to the scanning drive circuit region DAR2, or to the drive circuit region DAR3 having the precharge circuits.

As explained above, the configuration of each of the above embodiments is capable of providing an image display device provided with the active matrix substrate having high-mobility high-performance thin film transistor circuits in a drive circuit for driving pixel sections arranged in a matrix configuration, and consequently, provides high-quality image displays.

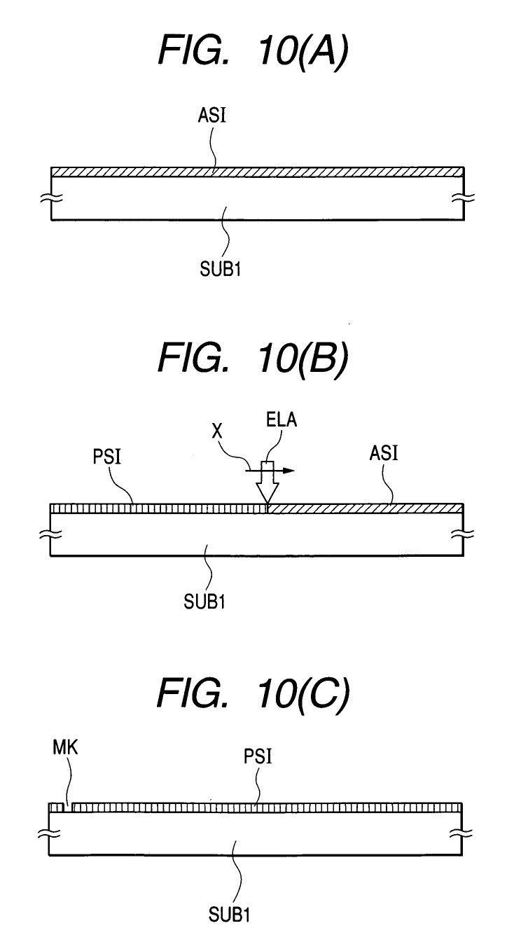

In the following, an embodiment of a method of fabricating an image display device in accordance with the present invention will be explained by reference to FIGS. 10(A) to 15. The following fabrication method will be explained by using a fabrication of a CMOS thin film transistor as an example, an n-type thin film transistor is formed by using a self-aligned GOLDD (Gate Overlapped Lightly Doped Drain) structure, and a p-type thin film transistor is formed by counterdoping.

FIGS. 10(A) to 15 illustrate a sequence of fabrication process steps. The sequence of the fabrication process steps will be explained by reference to FIG. 10(A) to FIG. 15.

First, prepared as an insulating substrate to be processed into an active matrix substrate SUB1 is a glass substrate SUB1 of about 0.3 mm to about 1.0 mm in thickness which is preferably a heat-resistant glass causing little mechanical deformation or contraction in heat treatment at a temperature in a range of from 400° C. to 600° C. It is preferable that continuously and uniformly deposited on the glass substrate SUB1 by a CVD method are a SiN film of about 50 nm in thickness and a SiO film of about 100 nm in thickness which serve as thermal and chemical barriers. Next an amorphous silicon film ASI is formed on the glass substrate SUB1 as by a CVD method. . . . FIG. 10(A)

Then the entire amorphous silicon film ASI on the glass substrate SUB1 is converted into a polysilicon film PSI by scanning excimer laser light ELA on the amorphous silicon film ASI in the x direction, thereby melting and crystallizing the amorphous silicon film ASI. . . . FIG. 10(B)

Incidentally, instead of using the excimer laser light ELA, other methods can be adopted which are crystallization of the amorphous silicon film ASI by annealing using solid-state pulsed laser, and forming of a polysilicon film directly by using a Cat-CVD (Catalytic CVD) method.

Next, by using photolithography techniques or dry etching processes, a positioning mark MK is formed which serves as a target used for positioning a location to be irradiated by pulse-modulated laser light or pseudo CW laser light SXL which are explained subsequently. This embodiment will be explained as using the pulse-width modulated laser light. . . . FIG. 10(C)

Next, the pulse-modulated laser light SXL is irradiated onto desired regions selectively and discontinuously by scanning the pulse-modulated laser light SXL in the x direction by using the mark MK as a reference point. This selective irradiation converts the polysilicon film PSI such that discontinuous converted regions (silicon films of the virtual tiles) SPSI are formed which have roughly-band-shaped-crystal silicon films with their grain boundaries continuous in the scanning direction.

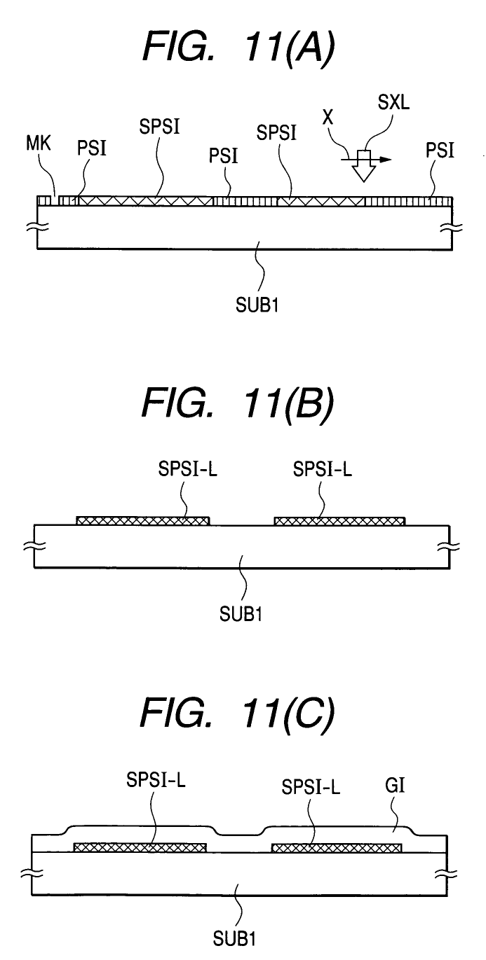

Here, by extending the laser light SXL scanning the drive circuit region DAR1 and/or the drive circuit region DAR2 in FIG. 1 such that the laser light SXL also covers the drive circuit region DAR3, virtual tiles are also formed in the drive circuit region DAR3 in a side adjacent to the drive circuit regions DAR1, DAR2, simultaneously with the formation of the virtual tiles in the drive circuit regions DAR1, DAR2. . . . FIG. 11(A)

Next, by using photolithography techniques, islands SPSI-L to be formed with thin film transistors are fabricated from the discontinuous converted regions (silicon films of the virtual tiles) SPSI of the roughly-band-shaped-crystal silicon films. . . . FIG. 11(B)

Next, a gate insulating film GI is formed to cover the islands SPSI-L in the discontinuous converted regions (silicon films of the virtual tiles) SPSI. . . . FIG. 11(C)

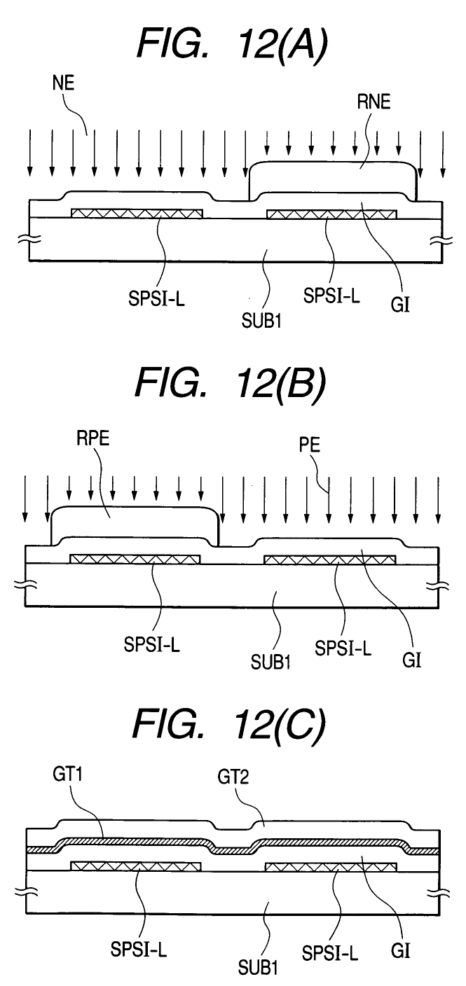

Next, ion implantation NE is carried out onto regions where n-type thin film transistors are to be formed, for the purpose of controlling their threshold voltages. At this time, a region where a p-type thin film transistor is to be fabricated is covered with a photoresist RNE. . . . FIG. 12(A)

Next, ion implantation PE is carried out onto the region where the p-type thin film transistor is to be formed, for the purpose of controlling its threshold voltage. At this time, the region where an n-type thin film transistor is to be fabricated is covered with a photoresist RPE. . . . FIG. 12(B)

Next, two layers of a metal gate film GT1 and a metal gate film GT2 intended for gate electrodes of the thin film transistors are formed on those regions by using a sputtering method or a CVD method. . . . FIG. 12(C)

Next, the metal gate films GT1 and GT2 are patterned by covering them with photoresists RN and using a photolithographic method. At this time, for the purpose of forming LDD (Lightly Doped Drain) regions, edges of the upper metal gate films GT2 are set back by a desired amount from those of the lower metal gate films GT1 by lateral etching of the upper metal gate films GT2.

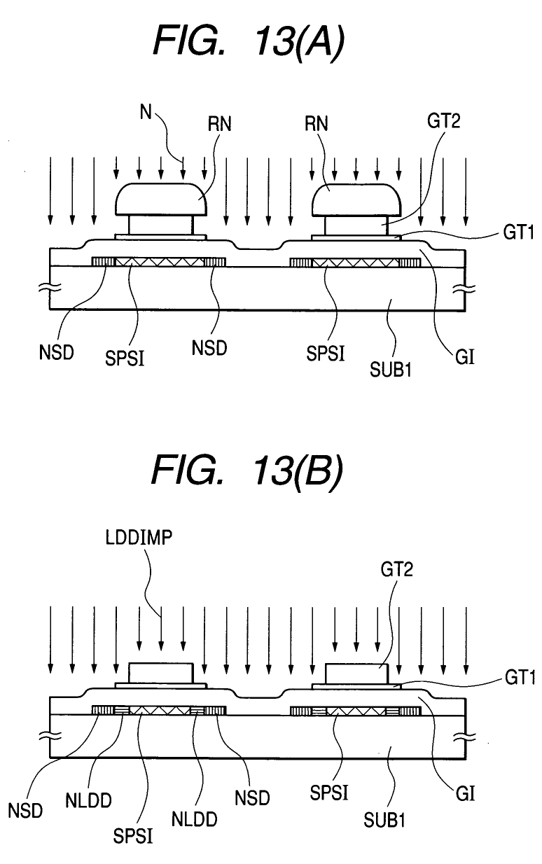

By implanting n-type impurities with the photoresists RN used as masks in this condition, source and drain regions NSD are formed for the n-type thin film transistor. . . . FIG. 13(A)

Next, after removing the photoresists RN, by performing implantation LDDIMP with the metal gate film GT2 used as a mask, LDD (Lightly Doped Drain) regions designated NLDD are formed for the n-type thin film transistor. . . . FIG. 13(B)

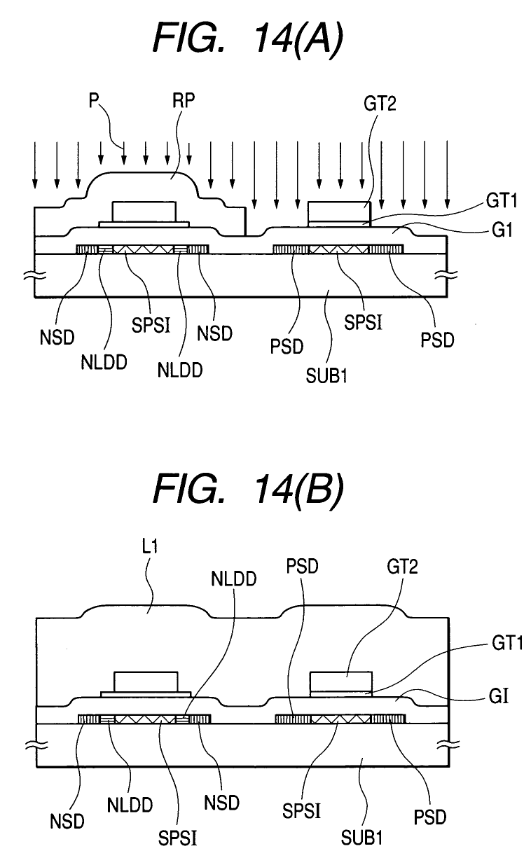

Next, after covering the region where the n-type thin film transistor is to be formed, with a photoresist the resistance pattern 29, source and drain regions PSD of the p-type thin film transistor are formed by implanting p-type impurities P into regions where the source and drain regions PSD of the p-type thin film transistor are to be formed. . . . FIG. 14(A)

Next, after removing the photoresist the resistance pattern 29, the implanted impurities are activated, and then an interlayer insulating film is formed as by a CVD method. . . . FIG. 14(B)

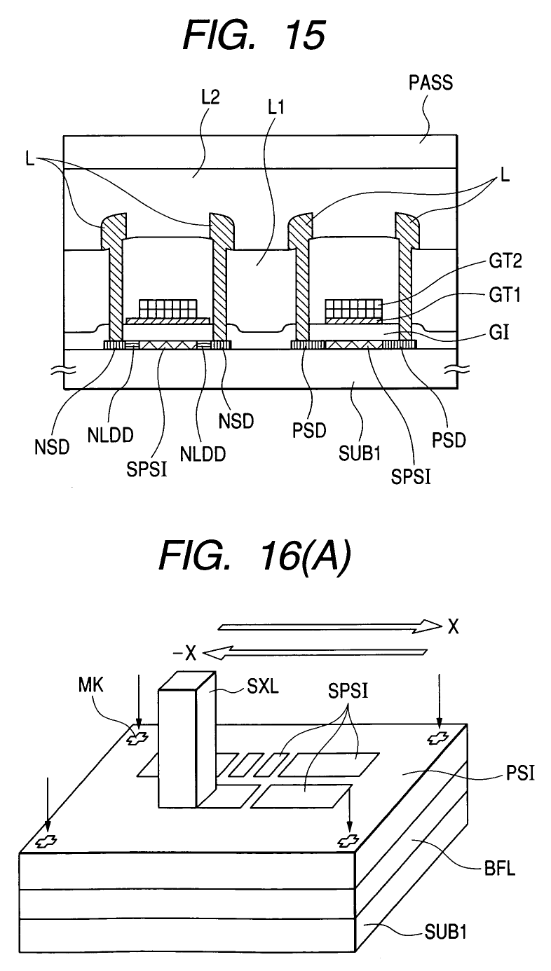

Next, contact holes are cut in the interlayer insulating film LI and the gate insulating film GI by using a photolithographic method, and then interconnection lines L are formed by connecting interconnection metal layers to source and drain regions NSD, PSD of the n-type and p-type thin film transistors, respectively, via the contact holes. Thereafter, an interlayer insulating layer L2 is formed, and then a protective insulating film PASS is formed. . . . FIG. 15

By the above-explained process, a CMOS (Complementary Metal Oxide Semiconductor) thin film transistor is formed in the discontinuous converted regions of the roughly-band-shaped-crystal silicon films (silicon films of the virtual tiles) SPSI. In general, n-type thin film transistors are prone to severe degradation, but this degradation is reduced by forming lightly doped regions LDD (Lightly Doped Drain regions) between a channel and a source region and between the channel and a drain region, respectively. The above-explained GOLDD has a structure in which a gate electrode overlaps with the lightly doped regions, and this structure reduces degradation in performance observed in the case of the LDD structure. In the case of p-type thin film transistors, the degradation is less serious than that of n-type thin film transistors, and usually p-type thin film transistors do not adopt the lightly doped regions LDD or GOLDD.

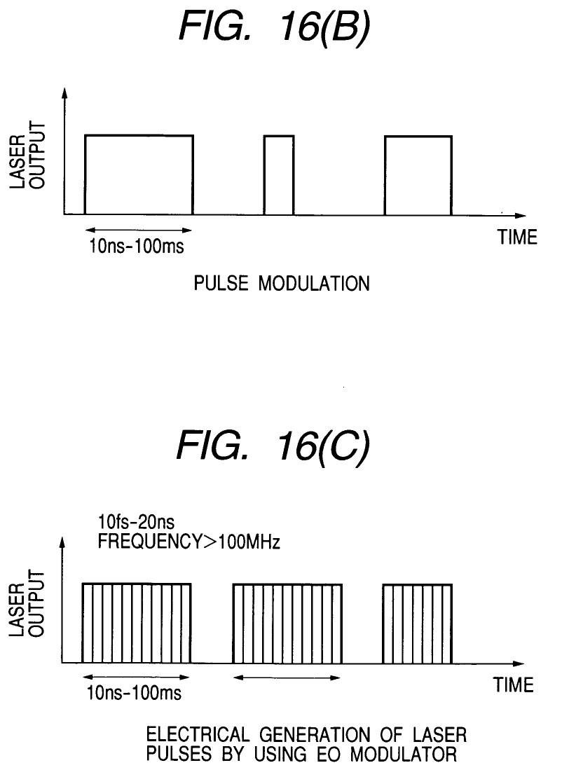

In the following, formation of the discontinuous converted regions (silicon films of the virtual tiles) of the roughly-band-shaped-crystal silicon films, which are features of the present invention, will be explained by reference to FIGS. 16(A) to 26.

FIGS. 16(A) to 16(C) illustrate a process for forming the discontinuous converted regions (silicon films of the virtual tiles) of the roughly-band-shaped-crystal silicon films, FIG. 16(A) is a schematic illustrating the process, FIG. 16(B) illustrates an example of a waveform of pulse-modulated laser, and FIG. 16(C) illustrates an example of a waveform of pseudo CW laser.

The discontinuous converted regions (silicon films of the virtual tiles) of the roughly-band-shaped-crystal silicon films are obtained by irradiating laser light SXL shown in FIG. 16(B) or 16(C) onto a polysilicon film PSI formed on a buffer layer BFL on an insulating substrate SUB1. The laser light SXL is the pulse-modulated laser light of FIG. 16(B) or the pseudo CW laser light as shown in FIG. 16(C), and is irradiated with a period in a range of from 10 ns to 100 ms.

As shown in FIG. 16(A), first the laser light SXL is scanned on the polysilicon film PSI in the positive x direction, then is shifted in the y direction, and then is scanned on the polysilicon film PSI in the negative (−) x direction, such that silicon films SPSI are obtained which are in the form of discontinuous converted regions having roughly-band-shaped crystals extending in the x and (−x) scanning directions. The insulating substrate SUB1 is provided with marks MK for positioning, and scanning of the laser light SXL is performed by using the mark MK as a target for positioning. In this way, the substrate SUB1 is scanned with intermittent irradiation of the laser light SXL, and consequently, the silicon films SPSI of the discontinuous converted regions of the roughly-band-shaped-crystal silicon films are arranged in an array of the virtual tiles.

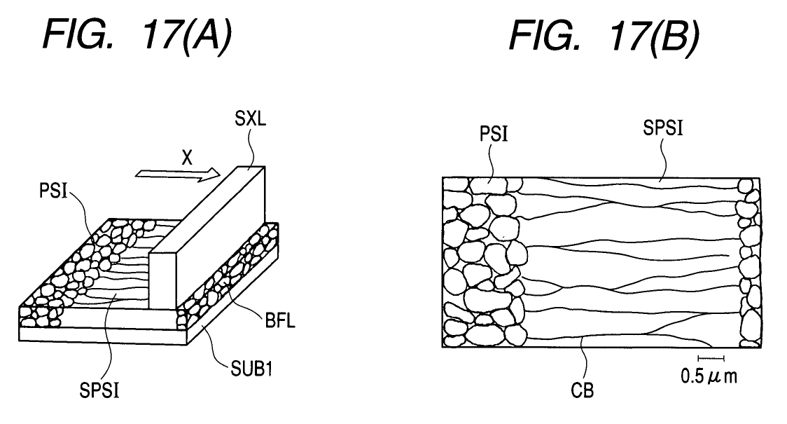

FIGS. 17(A) and 17(B) are illustrations of crystal structures of the roughly-band-shaped-crystal silicon film. FIG. 17(A) illustrates a manner of scanning the pulse-modulated laser light SXL, and FIG. 17(B) is a schematic illustrating a comparison in terms of crystal structure between the roughly-band-shaped-crystal silicon film SPSI formed by scanning of the pulse-modulated laser light SXL and a polysilicon film PSI remaining in the portions not scanned by the laser light SXL.

By scanning and converting the polysilicon film PSI with the pulse-modulated laser light SXL as shown in FIG. 17(A), obtained are the crystal structure of the roughly-band-shaped-crystal silicon film SPSI in which single-crystals extend in the form of bands in the scanning direction of the laser light as shown in FIG. 17(B). In FIG. 17(B), reference character CB denote grain boundaries.

The average grain size of the roughly-band-shaped-crystal silicon film SPSI is about 5 μm as measured in the scanning direction of the pulse-modulated laser light SXL, and is about 0.5 μm as measured in a direction perpendicular to the scanning direction, which corresponds to a distance between adjacent grain boundaries CB. Here, the grain size as measured in the scanning direction can be varied by adjusting the conditions of the pulse-modulated laser light SXL such as its energy (power), its scanning speed, and its pulse width. On the other hand, the average grain size of the polysilicon film PSI is about 0.6 μm with its grain size in a range of from 0.3 μm to 1.2 μm. These differences in crystal structure produces a great difference in electron mobility between thin film transistors using the polysilicon film PSI and the roughly-band-shaped-crystal silicon film SPSI, respectively.

The above-described roughly-band-shaped-crystal silicon film SPSI has the following features:

(a) A dominant orientation of the surface is {110}

(b) A dominant orientation of a plane approximately perpendicular to a direction of movement of carriers is {100}.

The two orientations stated in (a) and (b) can be evaluated by using an electron diffraction method or an EBSP (Electron Backscatter Diffraction Pattern) method.

(c) A defect density in the film is lower than 1×10¹⁷ cm⁻³. The number of crystal defects in the film is a value defined, based upon electrical characteristics, or quantitative evaluation of unpaired electrons by using electron spin resonance (ESR).

(d) The hole mobility in the film is in a range of from 50 cm²/V·s to 700 cm²/V·s.

(e) A thermal conductivity is temperature-dependent, and exhibits a maximum value at a certain temperature. Initially the thermal conductivity increases with increasing temperature, and exhibits a maximum value in a range of from 50 W/mK to 100 W/mK. Then, in a high-temperature region, the thermal conductivity decreases with increasing temperature. Thermal conductivity is a value evaluated and defined as by using a three-omega method.

(f) A Raman shift evaluated and defined by Raman scattering spectroscopic analysis of the film is in a range of from 512 cm⁻¹ to 518 cm⁻¹.

(g) A distribution of Σ values of crystal grain boundaries of the film is of a Gaussian shape having a maximum at Σ=11. Σ values are values measured by using an electron diffraction method or an EBSP (Electron Backscatter Diffraction Pattern) method.

(h) Optical constants of the film are characterized by the following.

For a wavelength of 500 nm, the refractive index n of the film is in a range of from 2.0 to 4.0, and the coefficient k of attenuation of the film is in a range of from 0.3 to 1.

For a wavelength of 300 nm, the refractive index n of the film is in a range of from 3.0 to 4.0, and the coefficient k of attenuation of the film is in a range of from 3.5 to 4.

These optical constants are values measured by using a spectro ellipsometer.

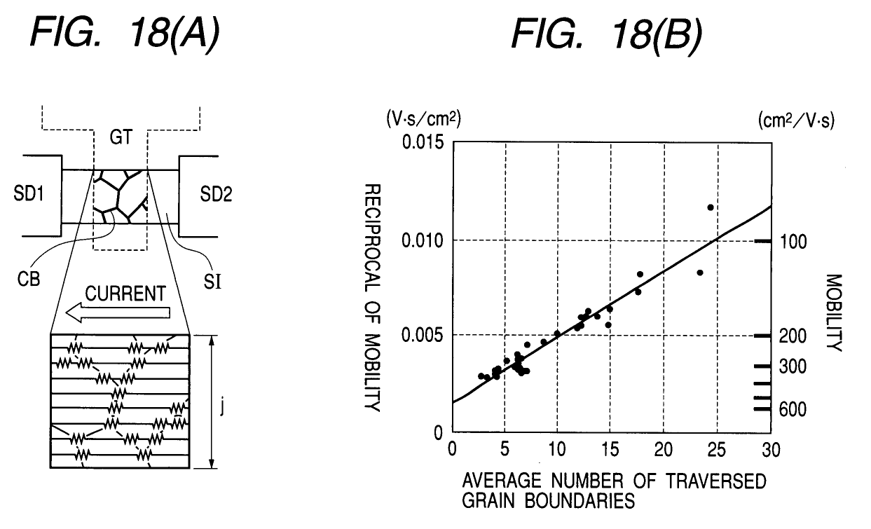

FIGS. 18(A) and 18(B) are illustrations for explaining differences in electron mobility in channels of thin film transistors due to differences in crystal structure between silicon films. FIG. 18(A) illustrates a structure of a channel of a thin film transistor, and a relationship between grain boundaries CB in the silicon film SI of the channel and the movement of electrons, and FIG. 18(B) shows a relationship between the number of grain boundaries traversed by a current flowing between the source SD1 and the drain SD2 and electron mobility. In a case where the silicon film SI is a polysilicon film PST, the current flowing from the drain SD2 to the source SD1 traverses many grain boundaries, but in a case where the silicon film SI is a roughly-band-shaped-crystal silicon film SPSI, since large single-crystals extend in directions of their growth, the current traverses a smaller number of grain boundaries. This relationship is shown in FIG. 18(B).

The average number C of grain boundaries traversed by a current is given by

C=ΣNi/j,

where

the width of a channel is divided into j equal portions in a direction perpendicular to a flowing direction of an electric current, and

Ni is the number of grain boundaries traversed by the electric current in its flowing direction.

In FIG. 18(B), the abscissa represents the average number of traversed grain boundaries, and the ordinate represents electron mobility (cm²/V·s) and its reciprocal (V·s/cm²). By arranging the source SD1 and the drain SD2 such that a current flows in a direction of crystal growth of the roughly-band-shaped-crystal silicon film SPSI forming the channel of a thin film transistor as described above, the electron mobility is increased extremely. That is to say, the operating speed of the thin film transistor is increased. Consequently, thin film transistors themselves can be fabricated with very small dimensions, and therefore interconnection lines R1, G1, B1, R2, G2, B2 are fabricated with a pitch smaller than a pixel pitch as already explained in connection with FIG. 3. As a result, large spaces are provided between adjacent circuits formed by the virtual tiles TL, and may be used as spaces for forming other interconnection lines.

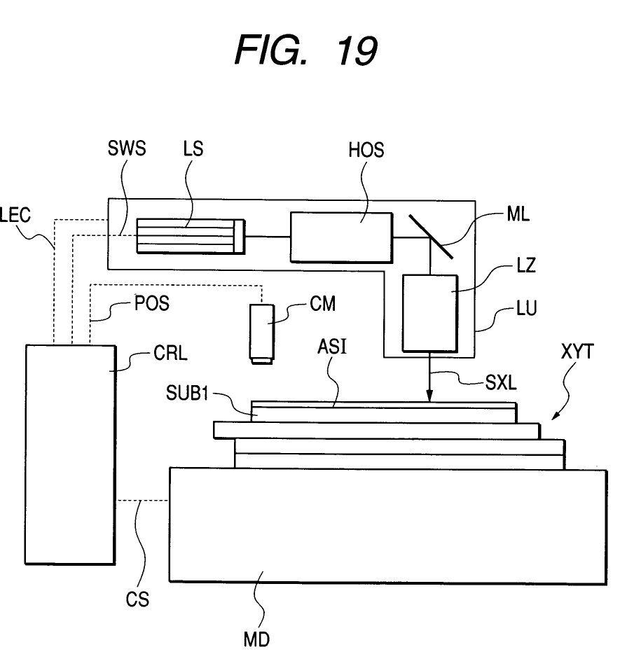

FIG. 19 is an illustration of an example of laser light irradiation equipment. In this irradiation equipment, a glass substrate SUB1 having a polysilicon film PSI formed thereon is placed on a stage XYT capable of x-y motion, and positioning is performed by using a camera CM for measuring reference positions. Measurement signals POS of the reference positions are fed to a control device CRL, a position to be irradiated is finely adjusted by a drive device MD based upon a control signal CS supplied to the drive device MD from the control device CRL. The stage XYT is moved in one direction (the x direction in FIG. 2) at a specified speed for scanning. The polysilicon film PSI is converted into a roughly-band-shaped-crystal silicon film SPSI by irradiating a pulse-modulated laser light SXL from an irradiation device LU onto the polysilicon film PSI in synchronism with the above mentioned scanning of the stage XYT.

By way of example, the irradiation device LU can form a desired irradiation beam by including an oscillator excited by a continuous-wave (CW) solid-state laser (laser diode) LS, an optical system HOS such as a homogenizer and an EO (Electro-Optic) modulator for modulating a pulse width, a reflective mirror ML, and a condenser lens system LZ. Irradiation time, irradiation intensity and the like of the laser light SXL are adjusted by using an ON-OFF signal SWS and a control signal LEC from the control device CRL.

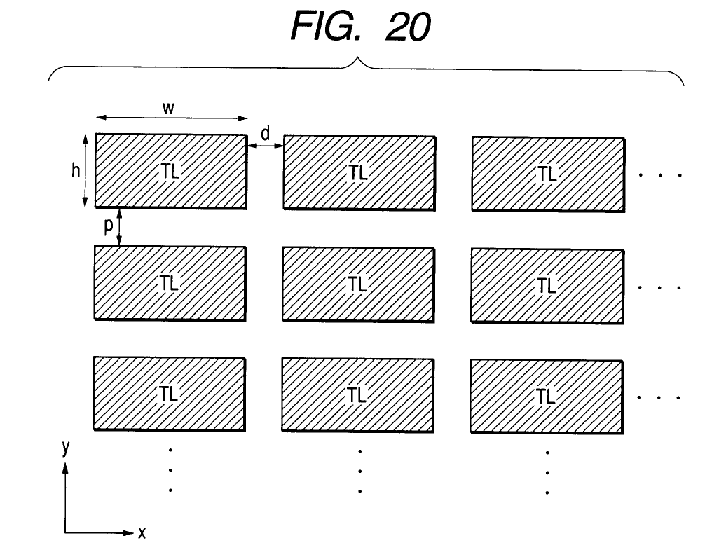

FIG. 20 is a plan view illustrating an example of a layout of the virtual tiles. In this example of the arrangement of the virtual tiles, the virtual tiles TL are arranged in plural rows in the drive circuit region DAR1 explained in connection with FIG. 1. The virtual tiles TL can be arranged in one or more rows, and also the virtual tiles TL in one of the rows can be offset in the longitudinal direction from the virtual tiles TL in adjacent ones of the rows, according to a circuit pattern to be fabricated. In this example, the virtual tiles TL are arranged in three rows (or three stages). The dimensions of each of the virtual tiles TL are as follows:

The length w of the virtual tile TL in the x direction is in a range of from 20 μm to 1 mm, the width h of the virtual tile TL in the y direction is in a range of from 20 μm to 1 mm, the spacing d between the virtual tiles TL adjacent to each other in the x direction is equal to or greater than 3 μm, and the spacing p between the virtual tiles TL adjacent to each other in they direction is equal to or greater than 3 μm. The size of the arrangement of the virtual tiles TL is restricted by the power of laser light and the size required for growing high-quality crystals stably.

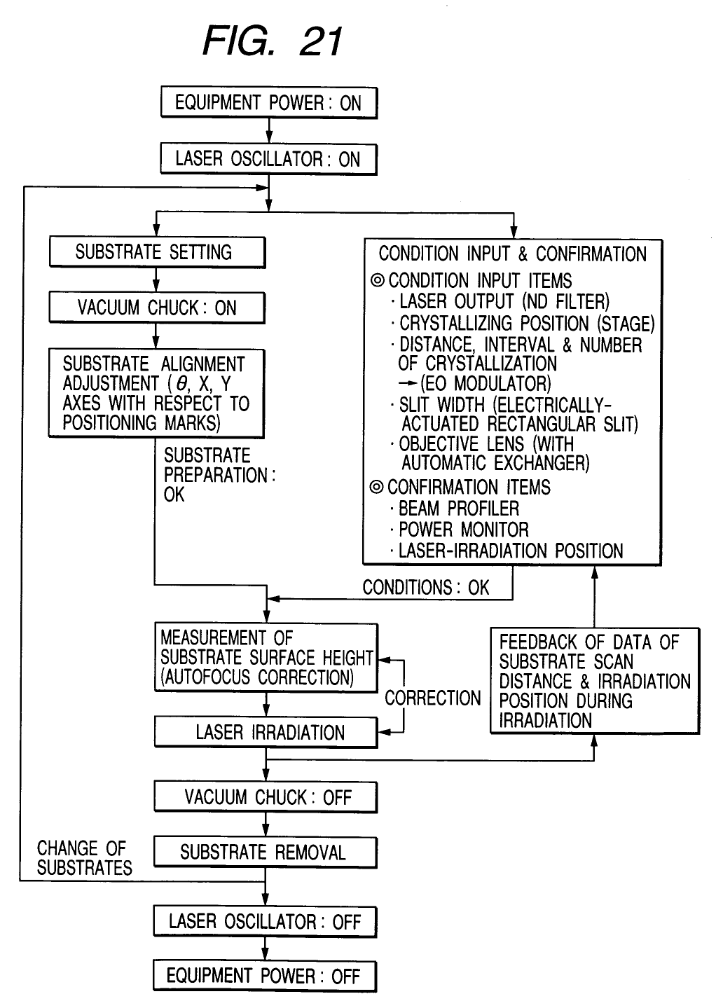

FIG. 21 is an illustration of an example of a laser irradiation process using the laser light irradiation equipment of FIG. 19. In FIG. 21, the insulating substrate is designated simply as the substrate.

Initially, an equipment power supply is turned ON and thereby the laser oscillator is turned ON, for the purpose of irradiating the pulse-modulated laser light SXL onto the insulating substrate having a polysilicon film thereon. The insulating substrate is placed on the drive stage XYT, and is fixed by a vacuum chuck. The preparation of the insulating substrate is completed by adjusting the x, y axes, the θ axis (a rotation angle in the x-y plane) to respective specified values using the positioning marks on the insulating substrate as targets.

On the other hand, various conditions are fed to the irradiation equipment, and some specified items are confirmed. The conditions to be fed include an output of laser (adjustment of an ND filter and the like), setting of a position to be crystallized (on the drive stage XYT), crystallization distance (the length of the virtual tiles in a direction of crystal growth), a spacing (a spacing between the virtual tiles), a tile number (the number of the virtual tiles to be formed), adjustment of the width of a slit in a path of the laser light, and setting of an objective lens. The crystallization distance, the spacing and the tile number are set at the EO modulator. The items to be confirmed include a beam profiler of the laser light, a power monitor, a laser light irradiation position, and the like.

After the completion of the insulating substrate, inputting of the operating conditions, and confirmations of the specified items, the height of the surface of the insulating substrate is measured, and then the laser light is irradiated by turning on an automatic focusing mechanism. The automatic focusing mechanism is adjusted by irradiating of the laser light, and the height of the surface of the insulating substrate is controlled. During the irradiation of the laser light, the scan distance of the insulating substrate and the irradiation position are fed back to the condition input side.

After completion of the process of irradiating the laser light onto the specified regions, the vacuum chuck is released, and the insulating substrate is removed from the drive stage XYT. Thereafter, another insulating substrate is set on the drive stage XYT, and the above-described operation is repeated. In this way, the above-described operation is repeated for a required number of insulating substrates, and after completion of the laser irradiation process on the required number of insulating substrates, the laser oscillator is turned OFF, and then the equipment power supply is turned OFF to complete the entire process.

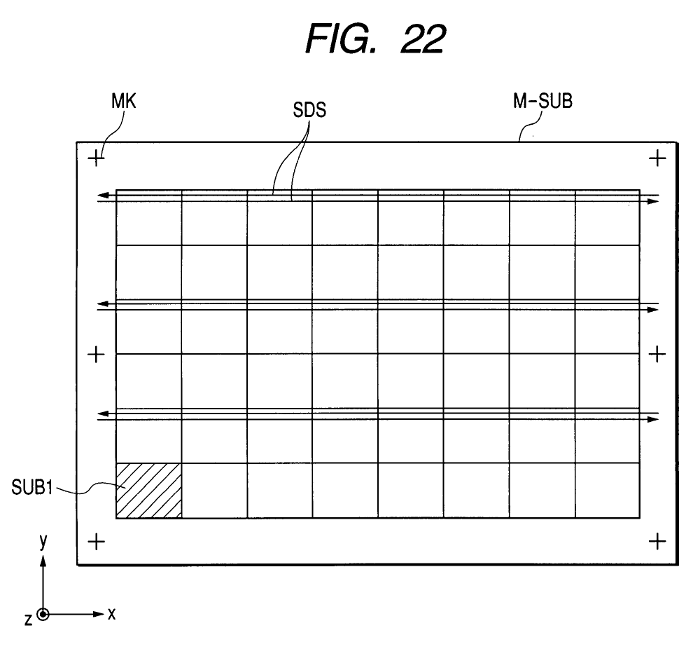

FIG. 22 is an illustration of operation of laser light scanning for forming virtual tiles of roughly-band-shaped-crystal silicon films SPSI on a large-sized multiple-device-material insulating substrate. In FIG. 22, reference character M-SUM denotes a large-sized multiple-device-material insulating substrate (hereinafter also called a large-sized material insulating substrate) which has a large number of identical circuit patterns, i.e., identical device patterns, each intended for an active matrix substrate SUB1 of each of image display devices. In FIG. 22, the large-sized material insulating substrate M-SUB is shown as having 8×6 (=48) identical device patterns, but it is not needless to say that the large-sized material insulating substrate M-SUB of the present invention is not limited to this configuration.

After positioning with respect to the drive circuit regions of the large-sized material insulating substrate M-SUB by using marks MK as targets, the pulse-modulated laser lights are scanned right to left, and then left to right, as indicated by arrows SDS in FIG. 22. In FIG. 22, the three laser lights are scanned in parallel with each other simultaneously such that desired virtual tiles can be formed on the large-sized material insulating substrate M-SUB in a short period of time.

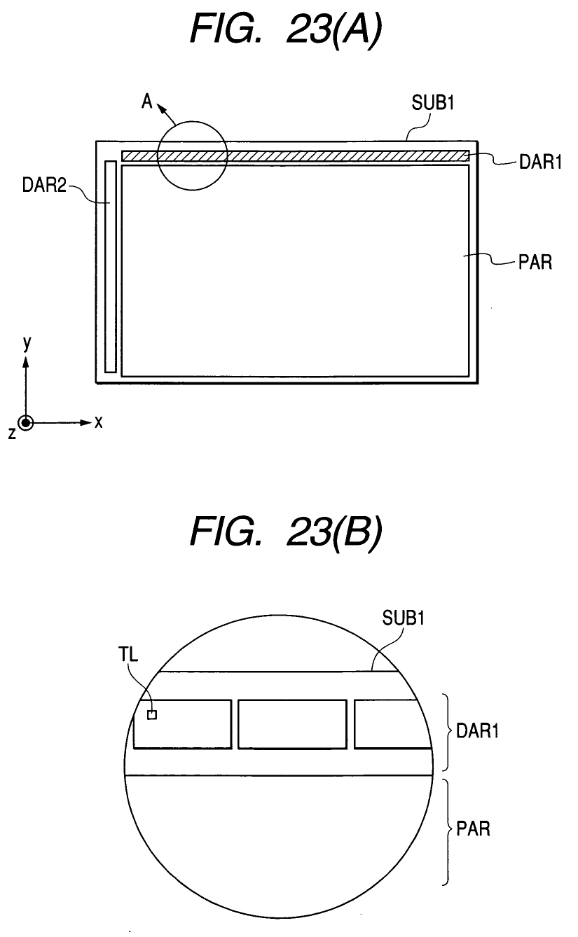

FIGS. 23(A) and 23(B) are plan views of an active matrix substrate for explaining an example of a position of the virtual tiles TL and their block fabricated by the operation explained in connection with FIG. 22, FIG. 23(A) is an entire plan view of the active matrix substrate and FIG. 23(B) is an enlarged plan view of a portion indicated by an arrow “A” in FIG. 23(A). In this example, blocks each composed of plural virtual tiles TL are arranged in a row in a side in the x direction where the data-signal drive circuit region DAR1 is formed on the active matrix substrate SUB1. Here, the plural virtual tiles TL are disposed over the entire region denoted by reference character SX in FIG. 2 or FIG. 9, or in the sampling circuit SAMP regions in FIG. 2, or in the latch circuit LT1 region, the latch circuit LT2 region, the digital-analog converter DAC, the buffer circuit BA in FIG. 9, and are divided into plural blocks.

Incidentally, to facilitate understanding of the present invention, in FIG. 23(B), the sizes and positions of the blocks of the virtual tiles TL are made different from those of the actual circuits.

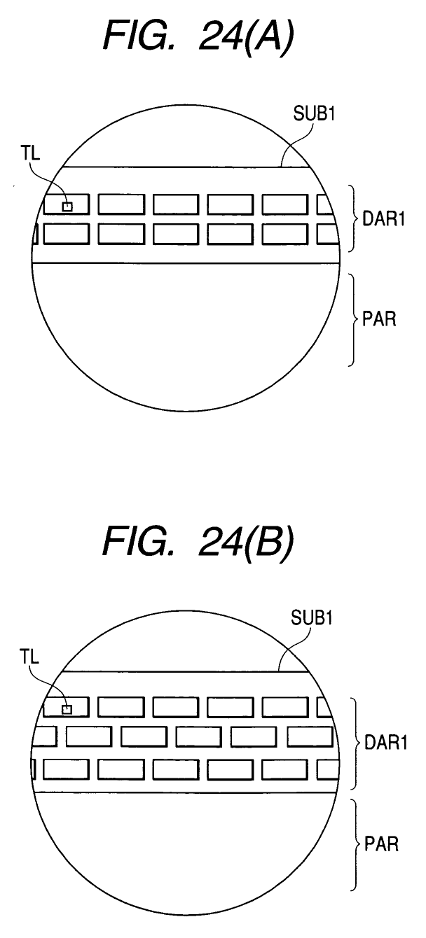

FIGS. 24(A) and 24(B) are enlarged plan view similar to that of FIG. 23(B), and are illustrations for explaining other arrangements of blocks of virtual tiles TL. In FIG. 24(A), blocks of the virtual tiles TL are arranged in two parallel rows in the x direction, and in FIG. 24(B), blocks of the virtual tiles TL are arranged in three parallel rows in the x direction, the blocks in one of the rows are offset in the longitudinal direction from the blocks in adjacent one of the rows. The size of individual blocks and the spacing between adjacent blocks can be varied according to circuit structures to which the blocks are applied. The virtual tiles TL may be arranged such that the virtual tiles TL in one row are offset in the longitudinal direction from the virtual tiles TL in adjacent rows, and may be arranged in a larger number of rows. This is equally applicable to virtual tiles TL constituting a block.

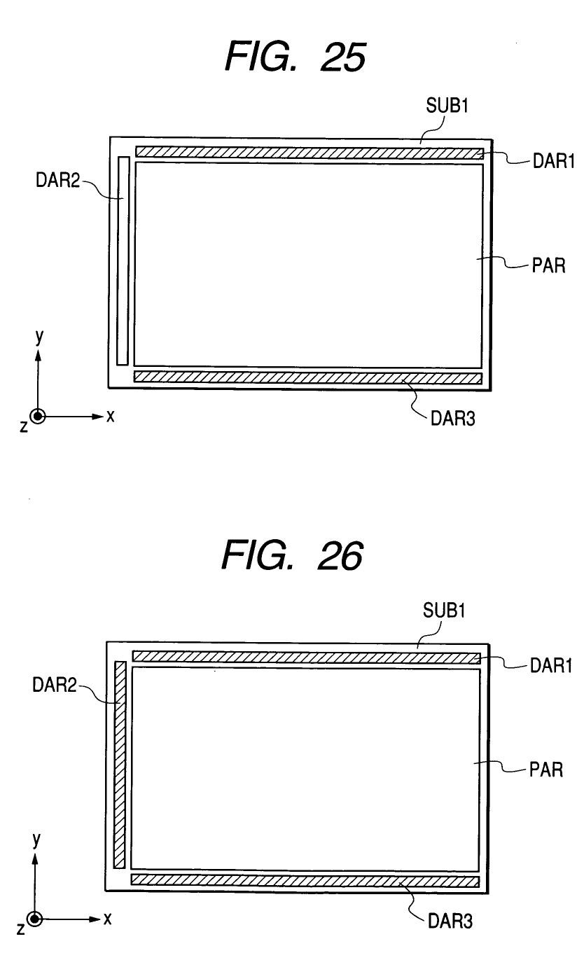

FIGS. 25 and 26 are plan views of two active matrix substrates illustrating other examples of positions of the virtual tiles TL, respectively. FIG. 25 illustrates an example in which the virtual tiles TL are applied to the two drive circuit regions DAR1 and DAR3 explained in connection with FIG. 1. FIG. 26 illustrates an example in which the virtual tiles TL are applied to the two drive circuit regions DAR1 and DAR3 and scanning drive circuit region DAR2 formed in a side of the active matrix substrate SUB1 extending in the y direction which have been explained in connection with FIG. 1. The configurations such as the arrangements of the individual virtual tiles TL and blocks are similar to those explained in connection with FIGS. 23(A) to 24(B).

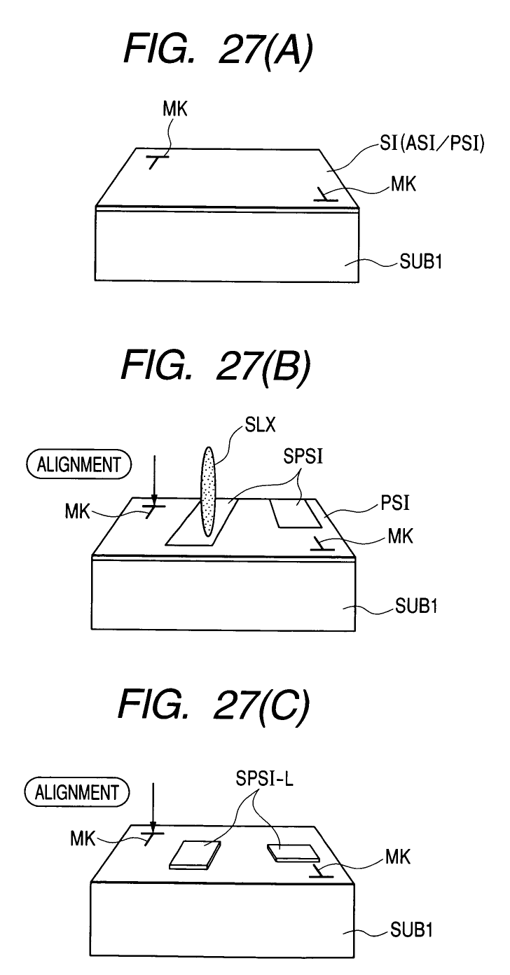

The following will explain the positioning marks used for forming the virtual tiles on an insulating substrate (an active matrix substrate). FIGS. 27(A) to 27(C) illustrate a first example of formation of the positioning marks on the active matrix substrate SUB1 and a laser light irradiation process using these positioning marks as targets.

In this example, the positioning marks MK are formed on a silicon film SI deposited on the active matrix substrate SUB1 by a photolithographic method (see FIG. 27(A)), then positioning (alignment) by using the marks MK as references is performed during subsequent irradiation of the laser light SXL (see FIG. 27(B)). Then, in a similar way using the marks MK as references, the roughly-band-shaped-crystal silicon films SPSI obtained by conversion by the irradiation of the laser light SXL are processed into islands SPSI-L (see FIG. 27(C)). Incidentally the marks MK may be formed in a stage in which the above-mentioned silicon film SI is an amorphous silicon film ASI or a polysilicon film PSI.

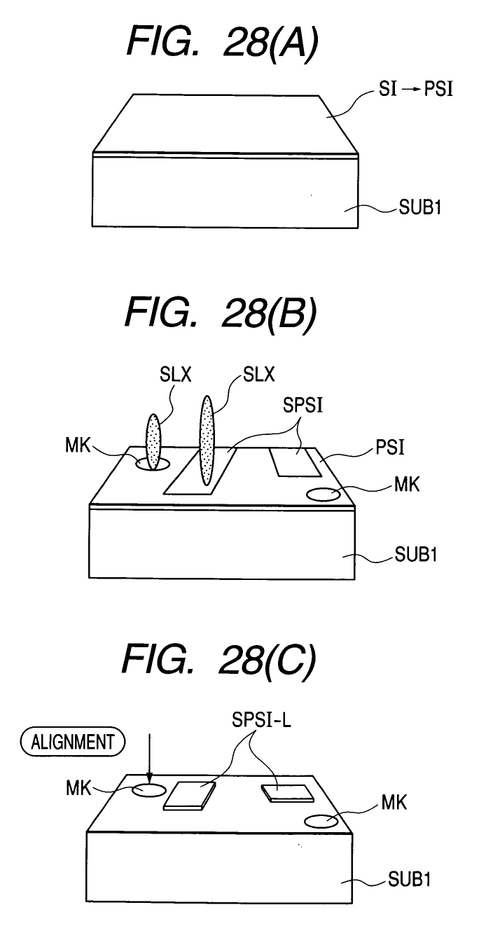

FIGS. 28(A) to 28(C) illustrate a second example of formation of positioning marks on the active matrix substrate SUB1 and a laser light irradiation process using these positioning marks as targets. In this example, first a polysilicon film PSI is formed on the active matrix substrate SUB1 (see FIG. 28(A)), and then, at the time of irradiating the laser light SLX onto the polysilicon film PSI, the positioning marks MK are formed by using the laser light SLX (see FIG. 28(B)). Then, during the subsequent formation of the islands SPSI-L, the positioning is performed by using the marks MK (FIG. 28(C)).

There is a difference in visible-light reflectance between the polysilicon film PSI and the roughly-band-shaped-crystal silicon film SPSI. It is possible to use this difference as the target for positioning. There is also a difference in height between the polysilicon film PSI and the roughly-band-shaped-crystal silicon film SPSI due to a difference in crystal grain size between them. Therefore it is possible to use steps in grain boundaries of portions of roughly-band-shaped-crystal silicon films located at positions intended for marks MK, as positioning targets. Further, marks MK may be formed by removing portions of the polysilicon film located at positions intended for marks MK by laser ablation. This method by laser ablation has an advantage that a photolithographic process step for forming the marks MK can be omitted.

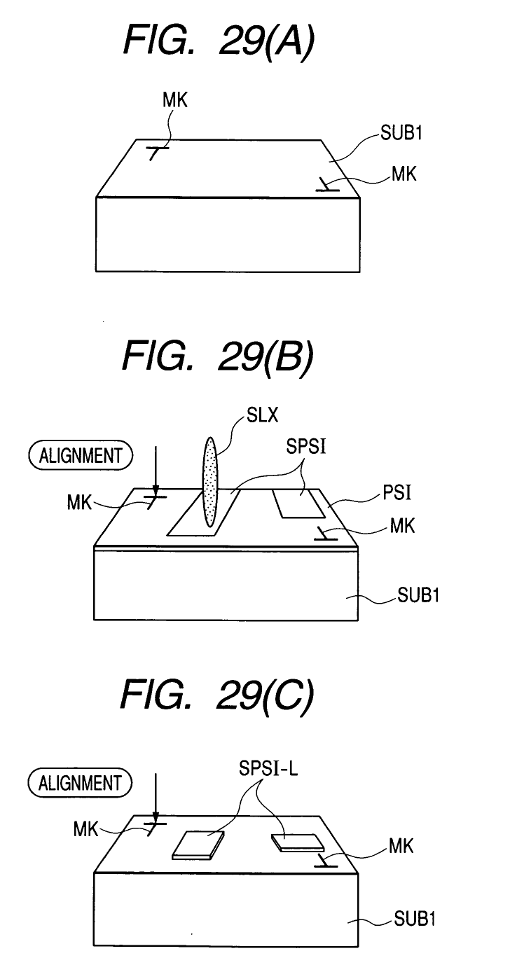

FIGS. 29(A) to 29(C) illustrate a third example of formation of positioning marks on the active matrix substrate SUB1 and a laser light irradiation process using these positioning marks as targets.

In this example, before a silicon film is formed on the active matrix substrate SUB1, marks MK are formed on the glass substrate SUB1 or an udercoating film formed thereon by using an etching method or a mechanical means (see FIG. 29(A)). Then the polysilicon film PSI is formed on the active matrix substrate SUB1, and the roughly-band-shaped-crystal silicon films SPSI is formed by irradiating the laser light SLX on the polysilicon film PSI using the marks MK as reference points (see FIG. 29(B)), and positioning during the subsequent formation process of the islands SPSI-L is performed by using these marks MK (see FIG. 29(C)).

As describe above, this embodiment is capable of converting polysilicon films into films having larger crystals such that directions of their crystal growth are oriented to reduce probability that a current flowing between a source and a drain of a thin film transistor traverses grain boundaries, and consequently, an operating speed of the thin film transistors is increased, and superior thin film transistor circuits can be obtained. Therefore, the thin film transistor circuits using semiconductor films of the roughly-band-shaped-crystal silicon films can be employed in drive circuit regions of an image display device.

The properties of the thin film transistors obtained by this embodiment are as follows:

In fabrication of N-channel MIS transistors, by way of example, field-effect electron mobility equal to or higher than about 300 cm²/V·s is obtained, variations in threshold voltage can be limited to within ±0.2 V. Consequently, a display device can be fabricated which uses an active matrix substrate of high-performance and high-reliability in operation, and superior in uniformity from device to device.

In this example, instead of ion implantation of phosphorus generating electron carriers, by ion implantation of boron generating hole carriers, p-channel MIS transistors can also be fabricated. Further, in the above-explained CMOS type circuits, improvement in frequency characteristics can be expected, and they are suitable for high-speed operation.

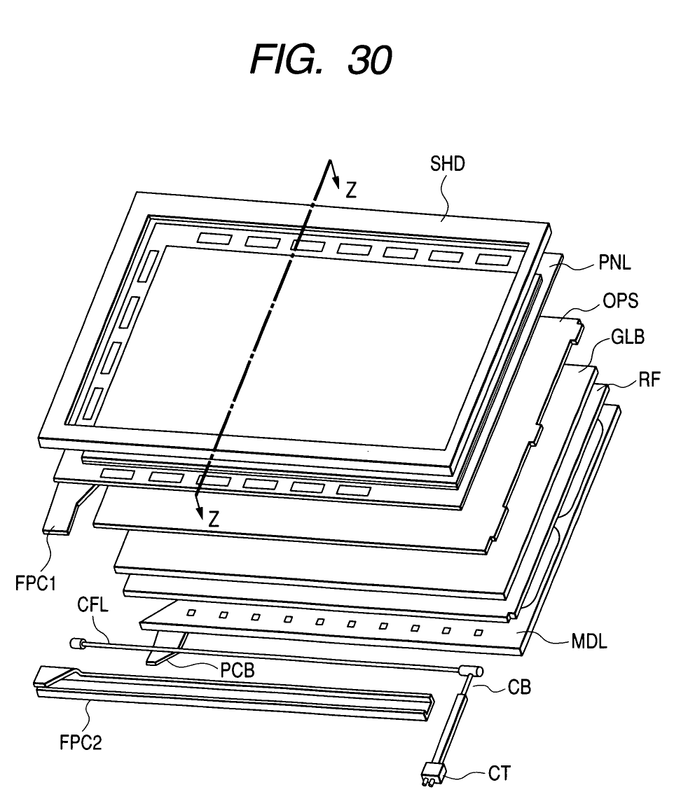

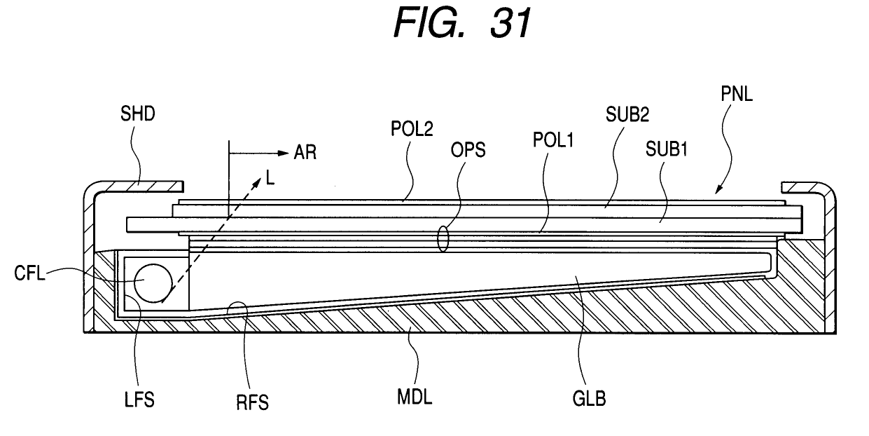

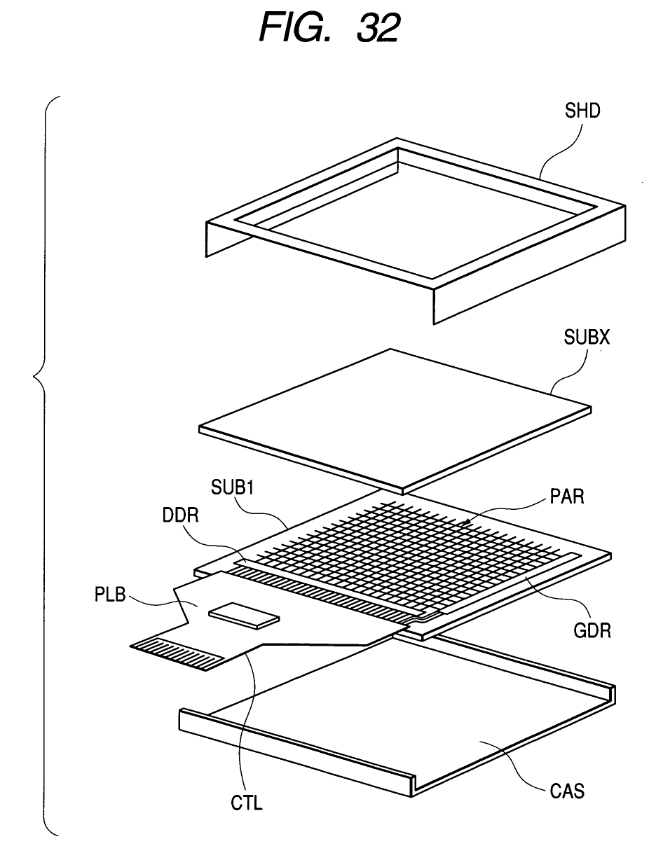

FIG. 30 is an exploded perspective view illustrating a configuration of a liquid crystal display device in accordance with a first embodiment of an image display device of the present invention, and FIG. 31 is a cross-sectional view of the liquid crystal display device of FIG. 30 taken along line Z-Z of FIG. 30. This liquid crystal display device is fabricated by using the above-explained active matrix substrate SUB1. In FIGS. 30 and 31, reference character PNL denotes a liquid crystal cell having a liquid crystal material sealed in a spacing between the active matrix substrate SUB1 and the color filter substrate SUB2 bonded together, and polarizers POL2, POL1 are attached in front of and behind the liquid crystal cell PNL, respectively reference character OPS denotes an optical compensating member formed of a light diffusing sheet and a prismatic sheet, GLB is a light-guide plate, CFL is a cold cathode fluorescent lamp, RFS is a reflective sheet, LFS is a lamp reflective sheet, SHD is a shield frame, and MDL is a molded case.

A liquid crystal orientation layer is formed on the active matrix substrate SUB1 having one of the configurations explained in connection with the above-described examples, and then orientation controlling capability is imparted to the liquid crystal orientation layer as by using a rubbing method.

After placing a sealing agent around the pixel region AR, the color filter substrate SUB2 having formed thereon an orientation layer similar to that of the active matrix substrate SUB1 is superposed on the active matrix substrate SUB1 with a specified spacing therebetween. After a liquid crystal material is filled into the spacing, the liquid-crystal-filling hole in the sealing member is closed by a sealing agent. Then, the polarizers POL2, POL1 are attached in front of and behind the thus fabricated liquid crystal cell PNL, respectively, and the liquid crystal display device is assembled by mounting a backlight comprised of the light-guide plate GLB, the cold cathode fluorescent lamp CFL and others on the liquid crystal cell PNL, with the optical compensating member OPS interposed therebetween. The drive circuits disposed at the peripheries of the liquid crystal cell PNL are supplied with data and timing signals via flexible printed circuit boards FPC1 and FPC2. Reference character PCB denotes circuit boards coupled between an external signal source and the respective flexible printed circuit boards FPC1, FPC2 and mounting thereon a timing converter for converting display signals supplied from the external signal source into signals of the type capable of being displayed by the liquid crystal display device, and the like.

The liquid crystal display device using the active matrix substrate of this embodiment employs the above-described superior polysilicon thin film transistor circuits for its pixel circuits, and consequently, is suitable for high-speed operation because of its superior current drive capabilities. Further, since there are little variations in threshold voltage of thin film transistors, the present invention has the feature that it is capable of providing a liquid crystal display device superior in uniformity of image quality at a low price.

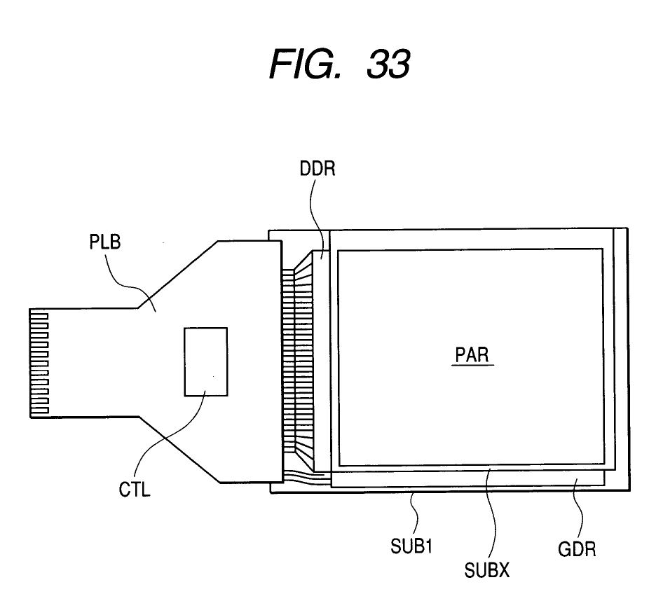

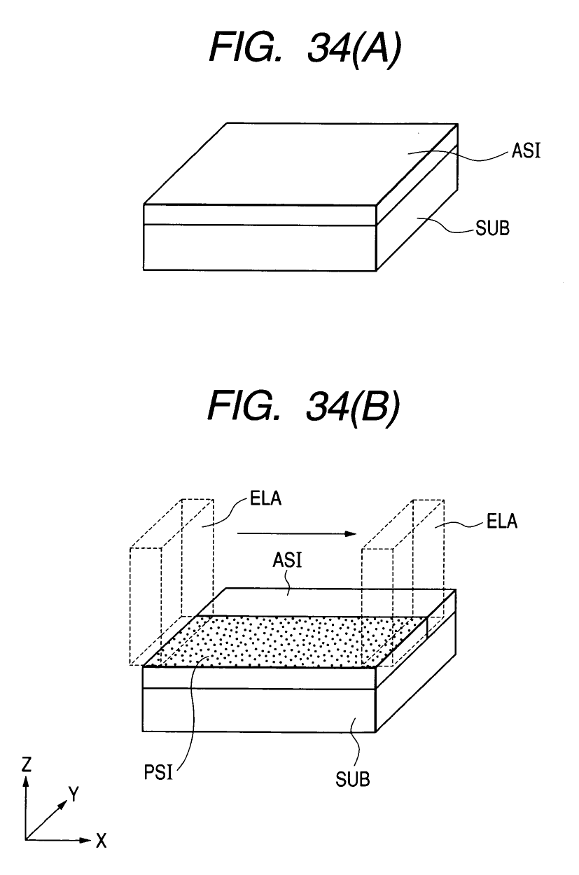

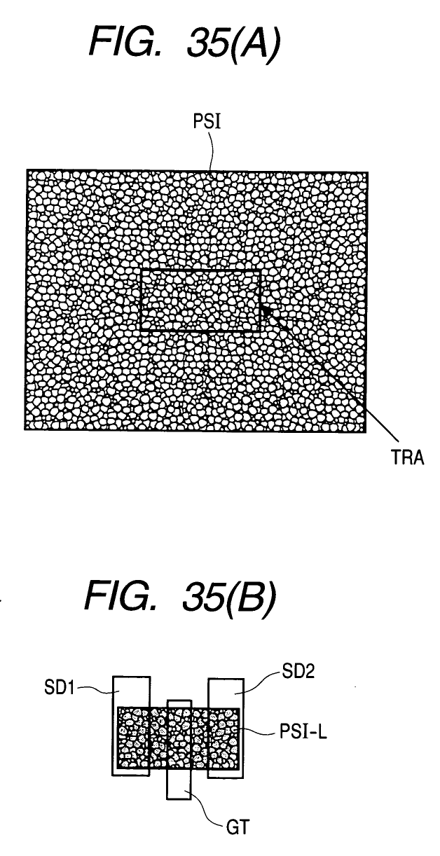

Further, an organic EL display device can be fabricated by using the active matrix substrate SUB1 of this embodiment. FIG. 32 is an exploded perspective view illustrating a configuration example of an organic EL display device in accordance with a second embodiment of an image display device of the present invention, and FIG. 33 is a plan view of the organic EL display device obtained by assembling the constituent components shown in FIG. 32 as an integral unit. Organic EL elements are fabricated on pixel electrodes formed on the active matrix substrate SUB1 in one of the above-described embodiments. Each of the organic EL elements is formed of a stack of evaporated layers comprising a hole transporting layer, a light-generating layer, an electron transporting layer, and a cathode metal layer from a surface of a pixel electrode in the order named. The active matrix substrate SUB1 having formed thereon the stack of the evaporated layers is sealed with a sealing substrate SUBX or a sealing can by using a sealing member disposed around the pixel region PAR of the active matrix substrate SUB1. In this organic EL display device, the drive circuit region DDR is supplied with display signals from an external signal source via a printed circuit board PLB. This printed circuit board PLB has an interface circuit chip CTL mounted thereon. The organic EL display device is assembled as an integral unit by fixing together a shield frame SHD serving as an upper case and a lower case CAS.

In active matrix driving of the organic EL display device, since the organic EL elements are of the current-driven light emission type, it is indispensable for production of images of good quality to adopt high-performance pixel circuits, and therefore it is desirable to employ pixel circuits formed of CMOS type thin film transistors. Further, thin film transistor circuits formed in the drive circuit regions are indispensable for high-speed operation and increasing of resolution capability. The active matrix substrate SUB1 of this example provides high performance satisfying such requirements. The organic EL display device employing the active matrix substrate of this example is one of the display devices capable of making the most of the features of this example.

The present invention is not limited to the active matrix substrates of the above-described image display devices, or is not limited to the configurations defined in the appended claims or the configurations described in the embodiments, and various changes and modifications may be made therein without departing from the true spirit and scope of the present invention, and the present invention may be applied to various semiconductor devices.

As explained above, the present invention forms discontinuous converted regions formed of roughly-band-shaped-crystal silicon films selectively converted by irradiating continuous-wave pulsed laser onto a silicon film intended for circuits of the drive circuit region disposed at peripheries of a pixel region on the active matrix substrate, and then forms drive circuits comprised of thin film transistor circuits in the discontinuous converted regions. Consequently, the present invention provides a high-performance image display device capable of reducing spaces occupied by the drive circuits, decreasing feature sizes of circuit components and being operated with high electron mobility.

What is claimed is:

1. An image display device having an active matrix substrate provided with a pixel region having a large number of pixels arranged in a matrix configuration, and a drive circuit region disposed outside of said pixel region for supplying drive signals to said large number of pixels via interconnection lines,
wherein
said drive circuit region comprises a plurality of stages of circuit sections successively processing an externally supplied display signal to produce a drive signal to be supplied to said pixel region, each of said plurality of stages of circuit sections having a different function,
at least one of said plurality of stages of circuit sections is provided with active elements fabricated in discontinuous converted regions formed of roughly-band-shaped-crystal silicon films having grain boundaries continuous in generally one direction, and
said active elements have a direction of movement of carriers therein in a direction of said grain boundaries.

2. An image display device according to claim 1, wherein said circuit sections of each of said plurality of stages are arranged along one side of said active matrix substrate at specified intervals at a periphery thereof.

3. An image display device according to claim 1, wherein circuit sections having said active elements formed therein are in a final output stage of said plurality of stages, and
said interconnection lines coupling said final output stage to said plurality of pixels are arranged at wider intervals on a pixel-region side thereof than on a final-output-stage side thereof.

4. An image display device according to claim 1, wherein said circuit sections having said active elements formed therein are arranged in two or more parallel rows along one side of said active matrix substrate at specified intervals at a periphery thereof.

5. An image display device according to claim 1, wherein said active elements are arranged along two opposed sides of said active matrix substrate at specified intervals at peripheries thereof.

6. An image display device according to claim 1, wherein areas of said circuit sections having said active elements formed therein vary with a scale thereof.

7. An image display device according to claim 1, wherein said circuit sections having said active elements formed therein are arranged in two or more parallel rows along one side of said active matrix substrate, and said circuit sections in one of said two or more rows are offset in longitudinal directions thereof from said circuit sections in an adjacent one of said two or more rows.

8. An image display device according to claim 1, wherein said active elements are arranged in two or more parallel row along one side of said active matrix substrate, and said active elements in one of said two or more parallel rows are offset in longitudinal directions thereof from said active elements in an adjacent one of said two or more parallel rows.

9. An image display device according to claim 1, wherein said active elements are thin film transistor.

10. An image display device according to claim 1, further comprising a color filter substrate and a liquid crystal layer, wherein said liquid crystal layer is sandwiched between said active matrix substrate and said color filter substrate superposed on said active matrix substrate with a specified spacing therebetween.

11. An image display device according to claim 1, wherein each of said pixels further comprises an organic EL layer.
